(19) United States
(12) Patent Application Publication
(10) Pub. No.: US 2019/0057074 A1
(43) Pub. Date: Feb. 21, 2019

(54) PATENT AUTOMATION SYSTEM

(71) Applicant: Michael Carey, Boulder, CO (US)

(72) Inventor: Michael Carey, Boulder, CO (US)

(21) Appl. No.: 16/103,624

(22) Filed: Aug. 14, 2018

Related U.S. Application Data
(60) Provisional application No. 62/546,481, filed on Aug. 16, 2017.

(51) Int. Cl. G06F 17/24; G06F 17/30

(52) U.S. Cl. CPC G06F 17/248; G06F 17/30312; G06F 2216/11; G06F 17/30011

(57) ABSTRACT

Methods, systems, and devices for automating patent preparation are described. A patent preparation system may facilitate efficient preparation of patent documents by identifying user input that includes an association of patent features (e.g., claims) with the components of a system that performs those features. The input may also include aspects of patent figures, claim types, acronyms, and other aspects of a patent disclosure. The user input may be used to create a patent application data object, which may then be used to create components of a patent including patent specification components and patent figures such as diagrams and flowcharts. The generated components may be combined with templates and information from a library of background information to generate patent documents.

### CROSS-REFERENCE TO RELATED APPLICATION

This application claims priority to, and the benefit of, U.S. Provisional Application Ser. No. 62546481 filed on Aug. 16, 2017, entitled PATENT AUTOMATION SYSTEM. The entire contents of the foregoing application are hereby incorporated by reference for all purposes.

### BACKGROUND

The following relates generally to preparing patent applications. Patent preparation is often performed by patent attorneys or agents who draft documents that are then submitted to the United States Patent and Trademark Office (USPTO). In some cases, the labor involved in preparing may involve the expenditure of a significant amount of time and may cost a significant amount of money. In some cases, the costs associated with patent preparation may inhibit inventors from patenting and benefitting from useful inventions.

### SUMMARY

A patent preparation system may facilitate efficient preparation of patent documents by identifying user input that includes an association of patent features (e.g., claims) with the components of a system that performs those features. The input may also include aspects of patent figures, acronyms, and other aspects of a patent disclosure. The user input may be used to create an application data object, which may then be used to create components of a patent including patent specification components and patent figures such as diagrams and flow charts. The generated components may be combined with templates to generate patent documents. An automated patent preparation system may therefore be used to reduce the time and cost associated with patent preparation. The system may also combine text ad drawings from a library of background or client specific information. The drawings may be stored in the form of images, diagrams, or logical trees representing the structure of the drawings.

In one embodiment, a method may include identifying a plurality of features of an invention, identifying a plurality of system components, identifying a correspondence between each of the plurality of features of the invention and a system component of the plurality of system components, and identifying a patent application data object, wherein the patent application data object is based at least in part on the plurality of features of the invention and the correspondence between each of the plurality of features of the invention and the system component of the plurality of system components.

In one embodiment, a non-transitory computer-readable medium may include instructions operable to cause a processor to identify a plurality of features of an invention, identify a plurality of system components, identify a correspondence between each of the plurality of features of the invention and a system component of the plurality of system components, and identify a patent application data object, wherein the patent application data object is based at least in part on the plurality of features of the invention and the correspondence between each of the plurality of features of the invention and the system component of the plurality of system components.

In one embodiment, an apparatus may include a processor, memory in electronic communication with the processor, and instructions stored in the memory. The instructions may be operable to cause the processor to identify a plurality of features of an invention, identify a plurality of system components, identify a correspondence between each of the plurality of features of the invention and a system component of the plurality of system components, and identify a patent application data object, wherein the patent application data object is based at least in part on the plurality of features of the invention and the correspondence between each of the plurality of features of the invention and the system component of the plurality of system components.

In one embodiment, an apparatus may include means for identifying a plurality of features of an invention, means for identifying a plurality of system components, means for identifying a correspondence between each of the plurality of features of the invention and a system component of the plurality of system components, and means for identifying a patent application data object, wherein the patent application data object is based at least in part on the plurality of features of the invention and the correspondence between each of the plurality of features of the invention and the system component of the plurality of system components.

Some examples of the method, non-transitory computer-readable medium, and apparatus described above may further include processes, features, means, or instructions for identifying a tree structure for the plurality of features of the invention, wherein the patent application data object may be identified based at least in part on the tree structure. In some examples of the method, non-transitory computer-readable medium, and apparatus described above, the plurality of features of the invention comprise claim features, background details, invention details, enabling details, invention embodiment, invention components, method steps, or any combination thereof.

Some examples of the method, non-transitory computer-readable medium, and apparatus described above may further include processes, features, means, or instructions for identifying a first subset of the plurality of features of the invention as independent claim features, and a second subset of the plurality of features of the invention as dependent claim features. Some examples of the method, non-transitory computer-readable medium, and apparatus described above may further include processes, features, means, or instructions for identifying a third subset of the plurality of features of the invention as non-claim features.

Some examples of the method, non-transitory computer-readable medium, and apparatus described above may further include processes, features, means, or instructions for generating a claims section or a summary section of a patent application document based on the first subset and the second subset. Some examples of the method, non-transitory computer-readable medium, and apparatus described above may further include processes, features, means, or instructions for generating a detailed description section of a patent application document based on the first subset, the second subset and the third subset.

Some examples of the method, non-transitory computer-readable medium, and apparatus described above may further include processes, features, means, or instructions for reading one or more invention feature input fields of a user interface, wherein the plurality of features of the invention may be identified based at least in part on the reading the invention feature input fields of the user interface.

In some examples of the method, non-transitory computer-readable medium, and apparatus described above, the user interface comprises a plurality of input sections, the plurality of input sections comprising an application data input section, a feature input section, a figure input section, an acronym input section, or any combination thereof. In some examples of the method, non-transitory computer-readable medium, and apparatus described above, the feature input section and the figure input section each comprise a nested tree structure of display document objects. In some examples of the method, non-transitory computer-readable medium, and apparatus described above, the feature input section comprises one or more fields for associating the plurality of features of the invention and a system component of the plurality of system components. In some examples of the method, non-transitory computer-readable medium, and apparatus described above, the user interface comprises a drag-and-drop function for manipulating a nested tree structure of the plurality of features of the invention, a figure of the invention, or both. In some examples of the method, non-transitory computer-readable medium, and apparatus described above, the user interface comprises an editing function for editing text of the plurality of features of the invention, a figure of the invention, or both. In some examples of the method, non-transitory computer-readable medium, and apparatus described above, the user interface comprises a structure editing function for manipulating a nested tree structure of the plurality of features of the invention, a figure of the invention, or both. In some examples of the method, non-transitory computer-readable medium, and apparatus described above, the structure editing function may be based at least in part on association between arrow buttons on a user keyboard and structure manipulation subroutines for the nested tree structure.

Some examples of the method, non-transitory computer-readable medium, and apparatus described above may further include processes, features, means, or instructions for identifying an in invalid input based on reading one or more invention feature input fields. Some examples of the method, non-transitory computer-readable medium, and apparatus described above may further include processes, features, means, or instructions for displaying a warning indication on the user interface based on the invalid input.

In some examples of the method, non-transitory computer-readable medium, and apparatus described above, the invalid input may be identified based at least in part on an information threshold, a missing input, a relationship between the one or more invention feature input fields, or any combination thereof. In some examples of the method, non-transitory computer-readable medium, and apparatus described above, the missing input comprises a missing system correspondence input for a feature of the plurality of features of an invention.

Some examples of the method, non-transitory computer-readable medium, and apparatus described above may further include processes, features, means, or instructions for displaying the plurality of features of the invention, the plurality of system components, the correspondence between each of the plurality of features of the invention and the system component of the plurality of system components, or any combination thereof on a user interface. In some examples of the method, non-transitory computer-readable medium, and apparatus described above, the user interface comprises a plurality of input sections, the plurality of input sections comprising an application data input section, a feature input section, a figure input section, an acronym input section, or any combination thereof.

Some examples of the method, non-transitory computer-readable medium, and apparatus described above may further include processes, features, means, or instructions for identifying a nested tree structure of display document objects based at least in part on a nested tree structure of the plurality of features of the invention, wherein the displaying may be based on the nested tree structure of display document objects. In some examples of the method, non-transitory computer-readable medium, and apparatus described above, the nested tree structure of display document objects comprises a hypertext markup language (HTML) structure, a markup language tree structure, a scalable vector graphics (SVG) structure, or any combination thereof.

Some examples of the method, non-transitory computer-readable medium, and apparatus described above may further include processes, features, means, or instructions for identifying a nested tree structure of display document objects based at least in part on a nested tree structure of figures of the invention.

Some examples of the method, non-transitory computer-readable medium, and apparatus described above may further include processes, features, means, or instructions for determining whether a feature of the plurality of features of the invention may be a claim feature, a device component, a method step, a discussion feature, a background feature, an enabling detail, a non-claim feature, a component relationship feature, or any combination thereof. In some examples of the method, non-transitory computer-readable medium, and apparatus described above, the determination may be based at least in part on a feature category indication of a user interface.

Some examples of the method, non-transitory computer-readable medium, and apparatus described above may further include processes, features, means, or instructions for identifying a plurality of claims, wherein the each of the plurality of claims comprises at least one of the plurality of features of the invention and wherein the patent application data object may be identified based at least in part on the plurality of claims.

Some examples of the method, non-transitory computer-readable medium, and apparatus described above may further include processes, features, means, or instructions for identifying a nested tree structure for the plurality of claims, wherein the nested tree structure may be based at least in part on a dependency relationship between individual claims of the plurality of claims.

Some examples of the method, non-transitory computer-readable medium, and apparatus described above may further include processes, features, means, or instructions for reading one or more invention feature input fields, wherein the plurality of claims of the invention may be identified based at least in part on the reading.

Some examples of the method, non-transitory computer-readable medium, and apparatus described above may further include processes, features, means, or instructions for identifying a plurality of claim types for each of the plurality of claims, wherein the plurality of claim types comprises a method claim type, a means plus function claim type, a computer readable medium claim type, a processor function claim type, a device claim type, a system claim type, a chemical composition claim type, a business method claim type, an apparatus claim type, or any combination thereof.

Some examples of the method, non-transitory computer-readable medium, and apparatus described above may further include processes, features, means, or instructions for identifying at least one patent figure, wherein the patent application data object may be identified based at least in part on the at least one patent figure.

Some examples of the method, non-transitory computer-readable medium, and apparatus described above may further include processes, features, means, or instructions for identifying a nested tree structure for the at least one patent figure, wherein the nested tree structure comprises a set of relationships among a plurality of method steps, a plurality of figure components, or both. In some examples of the method, non-transitory computer-readable medium, and apparatus described above, the at least one figure comprises a flowchart figure.

Some examples of the method, non-transitory computer-readable medium, and apparatus described above may further include processes, features, means, or instructions for identifying at least one method step based at least in part on the plurality of features of the invention, wherein the flowchart figure comprises the method step.

Some examples of the method, non-transitory computer-readable medium, and apparatus described above may further include processes, features, means, or instructions for identifying a system component for the at least one method step. In some examples of the method, non-transitory computer-readable medium, and apparatus described above, the system component for the at least one method step may be based at least in part on the correspondence between each of the plurality of features of the invention and the system component of the plurality of system components. In some examples of the method, non-transitory computer-readable medium, and apparatus described above, the at least one figure comprises a system diagram figure.

Some examples of the method, non-transitory computer-readable medium, and apparatus described above may further include processes, features, means, or instructions for identifying at least one figure component, wherein the system diagram figure comprises the at least one figure component.

Some examples of the method, non-transitory computer-readable medium, and apparatus described above may further include processes, features, means, or instructions for identifying a correspondence between the at least one figure component and a subset of the plurality of features of the invention based at least in part on the correspondence between each of the plurality of features of the invention and the system component of the plurality of system components. In some examples of the method, non-transitory computer-readable medium, and apparatus described above, the at least one figure comprises size information, location information, numbering information, shape information, stencil information, component relationship information or any combination thereof.

Some examples of the method, non-transitory computer-readable medium, and apparatus described above may further include processes, features, means, or instructions for identifying one or more acronym objects, wherein the patent application data object includes the one or more acronym objects. In some examples of the method, non-transitory computer-readable medium, and apparatus described above, the one or more acronym objects comprises a short version and a long version, wherein the short version comprises a subset of letters of the long version.

Some examples of the method, non-transitory computer-readable medium, and apparatus described above may further include processes, features, means, or instructions for transmitting the patent application data object to a database server. Some examples of the method, non-transitory computer-readable medium, and apparatus described above may further include processes, features, means, or instructions for receiving a verification from the database server in response to the transmission.

Some examples of the method, non-transitory computer-readable medium, and apparatus described above may further include processes, features, means, or instructions for saving the patent application data object in a database based at least in part on client information, a docket number, a patent identifier, or any combination thereof.

Some examples of the method, non-transitory computer-readable medium, and apparatus described above may further include processes, features, means, or instructions for identifying an indication comprising a printing indication, a save indication, a user modification, a timer, or any combination thereof from a user interface, wherein the patent application data object may be transmitted to the database server based at least in part on the indication. Some examples of the method, non-transitory computer-readable medium, and apparatus described above may further include processes, features, means, or instructions for receiving the patent application data object from a database server.

Some examples of the method, non-transitory computer-readable medium, and apparatus described above may further include processes, features, means, or instructions for transmitting client information, a docket number, a patent identifier, or any combination thereof to the database server, wherein the patent application data object may be received in response to the transmission. In some examples of the method, non-transitory computer-readable medium, and apparatus described above, the patent application data object comprises a JSON object, a JavaScript data object, an object oriented programming data object, a nodeJS data object, an extensible markup language (XML) object, an SQL data object, a graph database object, a relational database object, or any combination thereof.

Some examples of the method, non-transitory computer-readable medium, and apparatus described above may further include processes, features, means, or instructions for transmitting the patent application data object to a document generation server. Some examples of the method, non-transitory computer-readable medium, and apparatus described above may further include processes, features, means, or instructions for receiving a drawings document from the document generation server in response to the transmission. In some examples of the method, non-transitory computer-readable medium, and apparatus described above, the drawings document comprises a Microsoft Visio document, an image document, a portable document format (PDF) document, an SVG document, a diagram document or any combination thereof.

Some examples of the method, non-transitory computer-readable medium, and apparatus described above may further include processes, features, means, or instructions for receiving a document link from the document generation server in response to the transmission. Some examples of the method, non-transitory computer-readable medium, and apparatus described above may further include processes, features, means, or instructions for transmitting a download request to the document generation server, wherein the drawings document may be received based on the download request.

Some examples of the method, non-transitory computer-readable medium, and apparatus described above may further include processes, features, means, or instructions for receiving a specification document from the document generation server. In some examples of the method, non-transitory computer-readable medium, and apparatus described above, the specification document comprises a Microsoft Word document, an open office XML document, a PDF document, a text document, or any combination thereof.

Some examples of the method, non-transitory computer-readable medium, and apparatus described above may further include processes, features, means, or instructions for receiving a document link from the document generation server in response to the transmission. Some examples of the method, non-transitory computer-readable medium, and apparatus described above may further include processes, features, means, or instructions for transmitting a download request to the document generation server, wherein the specification document may be received based on the download request.

Some examples of the method, non-transitory computer-readable medium, and apparatus described above may further include processes, features, means, or instructions for performing a natural language processing analysis on the plurality of features of the invention. In some examples of the method, non-transitory computer-readable medium, and apparatus described above, the correspondence between each of the plurality of features of the invention and a system component of the plurality of system components may be identified based at least in part on the natural language processing analysis.

Some examples of the method, non-transitory computer-readable medium, and apparatus described above may further include processes, features, means, or instructions for modifying at least one feature of the plurality of features of the invention according to a set of grammatical rules based at least in part on the natural language processing analysis, wherein the patent application data object comprises the modified at least one feature. In some examples of the method, non-transitory computer-readable medium, and apparatus described above, the set of grammatical rules comprises a list of specified grammatical constructions and a set of generic grammatical rules.

Some examples of the method, non-transitory computer-readable medium, and apparatus described above may further include processes, features, means, or instructions for identifying a technology tag, wherein the patent application data object comprises the technology tag.

Some examples of the method, non-transitory computer-readable medium, and apparatus described above may further include processes, features, means, or instructions for receiving text from a database based at least in part on the technology tag. In some examples of the method, non-transitory computer-readable medium, and apparatus described above, the plurality of features of the invention may be based at least in part on the text received from the database.

Some examples of the method, non-transitory computer-readable medium, and apparatus described above may further include processes, features, means, or instructions for transmitting text to a database based at least in part on the technology tag. Some examples of the method, non-transitory computer-readable medium, and apparatus described above may further include processes, features, means, or instructions for receiving a figure object from a data base based at least in part on the technology tag. In some examples of the method, non-transitory computer-readable medium, and apparatus described above, the patent application data object comprises the figure object. In some examples of the method, non-transitory computer-readable medium, and apparatus described above, the figure object comprises a plurality of component objects organized according to a nested tree structure.

Some examples of the method, non-transitory computer-readable medium, and apparatus described above may further include processes, features, means, or instructions for transmitting a figure object to a database server based at least in part on the technology tag. Some examples of the method, non-transitory computer-readable medium, and apparatus described above may further include processes, features, means, or instructions for identifying a text input, wherein the plurality of features of an invention may be identified based at least in part on the text input.

Some examples of the method, non-transitory computer-readable medium, and apparatus described above may further include processes, features, means, or instructions for performing an automatic textual analysis comprising a natural language processing analysis, a punctuation analysis, a grammatical analysis or any combination thereof on the text input, wherein the plurality of features of the invention may be identified based at least in part on the automatic textual analysis.

In some examples of the method, non-transitory computer-readable medium, and apparatus described above, the text input may be identified based on a user selected text document, pasted text input, an email input, a web based communication, or any combination thereof.

Some examples of the method, non-transitory computer-readable medium, and apparatus described above may further include processes, features, means, or instructions for generating text for an application section of a patent application based at least in part on the application data object, wherein the application section comprises a claims section, a summary section, a background section, a references section, a brief description section, a detailed description section, a field of the invention section, a title section, an abstract section, or any combination thereof. In some examples of the method, non-transitory computer-readable medium, and apparatus described above, the text for the application section comprises XML markup, plain text, text markup, or any combination thereof. In some examples of the method, non-transitory computer-readable medium, and apparatus described above, the text for the application section comprises formatting information, numbering information, list information, or any combination thereof. In some examples of the method, non-transitory computer-readable medium, and apparatus described above, the text for the application section comprises dynamic fields, sequential numbering fields, reference fields corresponding to figure numbers, dynamically updating claim numbers, reference fields corresponding to claim dependencies, or any combination thereof. n some examples of the method, non-transitory computer-readable medium, and apparatus described above, the text for the claims section may be generated based at least in part on a nested tree structure of the plurality of features of the invention.

Some examples of the method, non-transitory computer-readable medium, and apparatus described above may further include processes, features, means, or instructions for identifying a claim form for each of a set of claim types of the patent application data object, wherein the text for the claims section may be generated based at least in part on the claim form for each of the set of claim types. In some examples of the method, non-transitory computer-readable medium, and apparatus described above, the claim form for each of the set of claim types comprises a feature grammatical form, a preamble form, or both. In some examples of the method, non-transitory computer-readable medium, and apparatus described above, the summary section comprises a plurality of repetitions for a first subset of the plurality of features of the invention and a single repetition for a second subset of the plurality of features of the invention based at least in part on the first subset being independent claim features and the second subset being dependent claim features. In some examples of the method, non-transitory computer-readable medium, and apparatus described above, the detailed description section comprises at least one description of a block diagram figure.

Some examples of the method, non-transitory computer-readable medium, and apparatus described above may further include processes, features, means, or instructions for generating a description for each of a set of components of a figure of the patent application data object based at least in part on a nested tree structure of the components within the patent application data object, wherein the at least one description of the block diagram figure comprises the generated description.

Some examples of the method, non-transitory computer-readable medium, and apparatus described above may further include processes, features, means, or instructions for identifying a subset of the plurality of features of the invention based at least in part on the correspondence between each of the plurality of features of the invention and the system component of the plurality of system components, wherein the generated description may be based at least in part on the subset of the plurality of features of the invention.

Some examples of the method, non-transitory computer-readable medium, and apparatus described above may further include processes, features, means, or instructions for identifying at least on feature based at least in part on a technology tag or a component name of the application data object, wherein the generated description may be based at least in part on the at least one feature. In some examples of the method, non-transitory computer-readable medium, and apparatus described above, the generated description comprises a dynamic field indicating that a component described in the generated description corresponds to a description of a figure different from the block diagram figure. In some examples of the method, non-transitory computer-readable medium, and apparatus described above, the detailed description section comprises at least one description of a flowchart. In some examples of the method, non-transitory computer-readable medium, and apparatus described above, the at least one description of the flowchart includes a description of a plurality of steps based on the plurality of features of the invention or a set of steps of a figure object of the application data object.

Some examples of the method, non-transitory computer-readable medium, and apparatus described above may further include processes, features, means, or instructions for identifying a system component of the plurality of system components based at least in part on a correspondence between the system component a step of the plurality of steps in the application data object. Some examples of the method, non-transitory computer-readable medium, and apparatus described above may further include processes, features, means, or instructions for generating component reference text based on the identified system component, wherein the description of a plurality of steps comprises the component reference text.

Some examples of the method, non-transitory computer-readable medium, and apparatus described above may further include processes, features, means, or instructions for identifying a set of figures that include the identified system component, wherein the component reference text may be generated based at least in part on the set of figures.

Some examples of the method, non-transitory computer-readable medium, and apparatus described above may further include processes, features, means, or instructions for identifying a set of components or flowchart steps. Some examples of the method, non-transitory computer-readable medium, and apparatus described above may further include processes, features, means, or instructions for identifying a reference number for each of the set of components or flowchart steps. Some examples of the method, non-transitory computer-readable medium, and apparatus described above may further include processes, features, means, or instructions for inserting the reference number for each of the set of components or flowchart steps into the detailed description section.

Some examples of the method, non-transitory computer-readable medium, and apparatus described above may further include processes, features, means, or instructions for performing a search function on the detailed description section based on the set of components or flowchart steps, wherein inserting the reference number may be based on the search function.

Some examples of the method, non-transitory computer-readable medium, and apparatus described above may further include processes, features, means, or instructions for performing a tree search function on a figure of the patent application data object. Some examples of the method, non-transitory computer-readable medium, and apparatus described above may further include processes, features, means, or instructions for identifying a count of the set of components or flowchart steps based at least in part on the tree search function, wherein the reference number for each of the set of components or flowchart steps may be based at least in part on the count. In some examples of the method, non-transitory computer-readable medium, and apparatus described above, the brief description section comprises reference fields that correspond to figure numbers located in the detailed description section.

Some examples of the method, non-transitory computer-readable medium, and apparatus described above may further include processes, features, means, or instructions for determining whether a feature of the plurality of features comprises an active feature, a passive feature, a substep, a device component, a component detail, or any combination thereof based on a natural language processing analysis of the feature, wherein the text for the application section may be based on the determination.

Some examples of the method, non-transitory computer-readable medium, and apparatus described above may further include processes, features, means, or instructions for performing a search and replace function for a set of acronyms of the application data object, wherein the text for the application section may be based on the search and replace function. In some examples of the method, non-transitory computer-readable medium, and apparatus described above, the brief description section comprises a listing of figures based at least in part on a set of figures of the application data object. In some examples of the method, non-transitory computer-readable medium, and apparatus described above, the listing of figures includes abbreviated ranges of figures based at least in part on one or more subsets of the set of figures having substantially similar figure names. In some examples of the method, non-transitory computer-readable medium, and apparatus described above, the brief description section comprises text based on an invention description field of the patent application data object.

Some examples of the method, non-transitory computer-readable medium, and apparatus described above may further include processes, features, means, or instructions for performing a grammatical transformation on at least one of the plurality of features of the invention, wherein the text for the application section may be based at least in part on the grammatical transformation.

Some examples of the method, non-transitory computer-readable medium, and apparatus described above may further include processes, features, means, or instructions for inserting the text for the application section into a patent application template to form a patent application document. In some examples of the method, non-transitory computer-readable medium, and apparatus described above, the patent application data object comprises an indication of the patent application template, wherein inserting the text for the claims section may be based at least in part on the indication of the patent application template.

Some examples of the method, non-transitory computer-readable medium, and apparatus described above may further include processes, features, means, or instructions for deleting excess markup from the patent application document. Some examples of the method, non-transitory computer-readable medium, and apparatus described above may further include processes, features, means, or instructions for identifying the excess markup based at least in part on a set of markup rules.

Some examples of the method, non-transitory computer-readable medium, and apparatus described above may further include processes, features, means, or instructions for deleting excess markup from the patent application template, wherein the patent application document may be based on deleting the excess markup. Some examples of the method, non-transitory computer-readable medium, and apparatus described above may further include processes, features, means, or instructions for identifying the excess markup based at least in part on a set of markup rules.

Some examples of the method, non-transitory computer-readable medium, and apparatus described above may further include processes, features, means, or instructions for identifying a one or more search terms within the patent application template, wherein the text for the application section may be inserted based on the identified one or more search terms. Some examples of the method, non-transitory computer-readable medium, and apparatus described above may further include processes, features, means, or instructions for identifying a bookmark element within the patent application template, wherein the text for the application section may be inserted based on the identified bookmark.

Some examples of the method, non-transitory computer-readable medium, and apparatus described above may further include processes, features, means, or instructions for identifying one or more empty run elements within the patent application template. Some examples of the method, non-transitory computer-readable medium, and apparatus described above may further include processes, features, means, or instructions for merging the one or more empty runs. Some examples of the method, non-transitory computer-readable medium, and apparatus described above may further include processes, features, means, or instructions for identifying one or more text runs. Some examples of the method, non-transitory computer-readable medium, and apparatus described above may further include processes, features, means, or instructions for generating one or more text run markup sections based on the text runs. Some examples of the method, non-transitory computer-readable medium, and apparatus described above may further include processes, features, means, or instructions for identifying a set of paragraph properties. Some examples of the method, non-transitory computer-readable medium, and apparatus described above may further include processes, features, means, or instructions for generating a paragraph markup section based at least in part on the one or more text run markup sections and the set of paragraph properties, wherein the text for the application section comprises the paragraph markup section.

Some examples of the method, non-transitory computer-readable medium, and apparatus described above may further include processes, features, means, or instructions for inserting a paragraph ending markup at the beginning of the text for the application section and a paragraph beginning markup at the end of the application section. Some examples of the method, non-transitory computer-readable medium, and apparatus described above may further include processes, features, means, or instructions for transforming a gerund form of a feature of the plurality of features of the invention to an infinitive form of the feature, wherein the text of the application section may be based at least in part on the transformation.

Some examples of the method, non-transitory computer-readable medium, and apparatus described above may further include processes, features, means, or instructions for transforming an infinitive form of a feature of the plurality of features of the invention to a gerund form of the feature, wherein the text of the application section may be based at least in part on the transformation.

Some examples of the method, non-transitory computer-readable medium, and apparatus described above may further include processes, features, means, or instructions for identifying a first letter of a component of the plurality of system components. Some examples of the method, non-transitory computer-readable medium, and apparatus described above may further include processes, features, means, or instructions for identifying an article based on the first letter. Some examples of the method, non-transitory computer-readable medium, and apparatus described above may further include processes, features, means, or instructions for inserting the article into the text of the application section.

Some examples of the method, non-transitory computer-readable medium, and apparatus described above may further include processes, features, means, or instructions for identifying a first letter of a sentence. Some examples of the method, non-transitory computer-readable medium, and apparatus described above may further include processes, features, means, or instructions for replacing the first letter of a sentence with a capitalized version of the first letter of the sentence, wherein the text of the application section may be based at least in part on the replacement.

Some examples of the method, non-transitory computer-readable medium, and apparatus described above may further include processes, features, means, or instructions for identifying a list of elements. Some examples of the method, non-transitory computer-readable medium, and apparatus described above may further include processes, features, means, or instructions for identifying the last element of the list of elements, the penultimate element of the list of elements, or both. Some examples of the method, non-transitory computer-readable medium, and apparatus described above may further include processes, features, means, or instructions for appending a separator to one or more elements of the list of elements based at least in part on the identified last element of the list of elements, the identified penultimate element of the list of elements, or both. Some examples of the method, non-transitory computer-readable medium, and apparatus described above may further include processes, features, means, or instructions for generating a text list of the list of elements based at least in part on the list of elements and the appended separators to the one or more elements, wherein the text of the application section may be based at least in part on the text list.

Some examples of the method, non-transitory computer-readable medium, and apparatus described above may further include processes, features, means, or instructions for identifying a file name for a patent application document based at least in part on the patent application data object. Some examples of the method, non-transitory computer-readable medium, and apparatus described above may further include processes, features, means, or instructions for generating the patent application document based at least in part on the patent application data object. Some examples of the method, non-transitory computer-readable medium, and apparatus described above may further include processes, features, means, or instructions for saving the patent application document based at least in part on the file name.

Some examples of the method, non-transitory computer-readable medium, and apparatus described above may further include processes, features, means, or instructions for transmitting a document link to the patent application document based on the file name. Some examples of the method, non-transitory computer-readable medium, and apparatus described above may further include processes, features, means, or instructions for generating a drawings document based at least in part on the patent application data object.

Some examples of the method, non-transitory computer-readable medium, and apparatus described above may further include processes, features, means, or instructions for transmitting the drawings document to a browser based application. In some examples of the method, non-transitory computer-readable medium, and apparatus described above, the drawings document comprises a Microsoft Visio document, a diagram document, an SVG document, an image document, a PDF document, or any combination thereof.

Some examples of the method, non-transitory computer-readable medium, and apparatus described above may further include processes, features, means, or instructions for generating at least one flowchart figure, at least one diagram figure, or both based on the patent application data object, wherein the drawings document comprises the at least on flowchart figure, the at least one diagram figure, or both. In some examples of the method, non-transitory computer-readable medium, and apparatus described above, the at least one flowchart figure, the at least one diagram figure, or both comprise an XML object that includes a plurality of XML shape objects.

Some examples of the method, non-transitory computer-readable medium, and apparatus described above may further include processes, features, means, or instructions for generating at least one step object, wherein the at least one flowchart figure comprises the at least one step object. In some examples of the method, non-transitory computer-readable medium, and apparatus described above, the step object comprises a rectangular shape, a diamond shape, a circular shape, an oval shape, a rectangular shape with rounded corners, or any combination thereof. In some examples of the method, non-transitory computer-readable medium, and apparatus described above, the step object comprises text based at least in part on one of the plurality of features of the invention.

Some examples of the method, non-transitory computer-readable medium, and apparatus described above may further include processes, features, means, or instructions for performing a capitalization function on the text of the step object. Some examples of the method, non-transitory computer-readable medium, and apparatus described above may further include processes, features, means, or instructions for performing a text simplification function on the text of the step object. In some examples of the method, non-transitory computer-readable medium, and apparatus described above, the step object comprises a lead line object. In some examples of the method, non-transitory computer-readable medium, and apparatus described above, the lead line object comprises a Non-uniform rational basis spline (NURBS) object. In some examples of the method, non-transitory computer-readable medium, and apparatus described above, the step object comprises an arrow object. In some examples of the method, non-transitory computer-readable medium, and apparatus described above, the step object comprises a reference number. In some examples of the method, non-transitory computer-readable medium, and apparatus described above, the reference number comprises a dynamic page reference.

Some examples of the method, non-transitory computer-readable medium, and apparatus described above may further include processes, features, means, or instructions for identifying a number of steps of the at least one flowchart figure, wherein the reference number may be based on the number of steps.

Some examples of the method, non-transitory computer-readable medium, and apparatus described above may further include processes, features, means, or instructions for identifying a standard distance between reference numbers and step objects. Some examples of the method, non-transitory computer-readable medium, and apparatus described above may further include processes, features, means, or instructions for determining a location of the step object. Some examples of the method, non-transitory computer-readable medium, and apparatus described above may further include processes, features, means, or instructions for determining a location of the reference number based at least in part on the location of the step object and the standard distance. In some examples of the method, non-transitory computer-readable medium, and apparatus described above, the at least one flowchart figure comprises a plurality of arrow objects, wherein each of the arrow objects may have a location between two step objects.

Some examples of the method, non-transitory computer-readable medium, and apparatus described above may further include processes, features, means, or instructions for identifying a location of a step object. Some examples of the method, non-transitory computer-readable medium, and apparatus described above may further include processes, features, means, or instructions for identifying a standard distance between step objects and arrow objects. Some examples of the method, non-transitory computer-readable medium, and apparatus described above may further include processes, features, means, or instructions for determining the location of an arrow object of the plurality of arrow objects based at least in part on the location of the step object and the standard distance.

Some examples of the method, non-transitory computer-readable medium, and apparatus described above may further include processes, features, means, or instructions for identifying a size of a first step object from a set of step objects of the at least one flowchart figure, wherein the size of the first step object may be based at least in part on a length of text of the first step object. Some examples of the method, non-transitory computer-readable medium, and apparatus described above may further include processes, features, means, or instructions for identifying a location of the first step object. Some examples of the method, non-transitory computer-readable medium, and apparatus described above may further include processes, features, means, or instructions for determining a location of a second step object based at least in part on size of the first step object and the location of the first step object or based on a size of the second step object and the location of the first step object.

Some examples of the method, non-transitory computer-readable medium, and apparatus described above may further include processes, features, means, or instructions for identifying a standard gap distance, wherein the location of the second step object may be determined based at least in part on the standard gap distance.

Some examples of the method, non-transitory computer-readable medium, and apparatus described above may further include processes, features, means, or instructions for determining a size for each step object of a set of step objects of the at least one flowchart figure. Some examples of the method, non-transitory computer-readable medium, and apparatus described above may further include processes, features, means, or instructions for determining a total size based at least in part on the size for each step object. Some examples of the method, non-transitory computer-readable medium, and apparatus described above may further include processes, features, means, or instructions for determining a location of the at least one flowchart figure based on the total size. Some examples of the method, non-transitory computer-readable medium, and apparatus described above may further include processes, features, means, or instructions for determining a location of each step object of the at least one flowchart figure based on the location of the at least one flowchart figure.

Some examples of the method, non-transitory computer-readable medium, and apparatus described above may further include processes, features, means, or instructions for performing a depth first search or a breadth first search on the set of step objects of the at least one flowchart figure, wherein the total size may be based at least in part on the depth first search or the breadth first search. In some examples of the method, non-transitory computer-readable medium, and apparatus described above, the at least one flowchart figure comprises a NURBS object.

Some examples of the method, non-transitory computer-readable medium, and apparatus described above may further include processes, features, means, or instructions for identifying a master shape. Some examples of the method, non-transitory computer-readable medium, and apparatus described above may further include processes, features, means, or instructions for modifying one or more aspects of the master shape based at least in part on the patent application data object, wherein the at least one flowchart figure, the at least one diagram figure, or both may be based on the modified master shape. In some examples of the method, non-transitory computer-readable medium, and apparatus described above, the master shape comprises an arrow master shape, a lead line master shape, a device master shape, a bus master shape, an electrical component master shape, a label master shape, or any combination thereof. In some examples of the method, non-transitory computer-readable medium, and apparatus described above, the at least one diagram figure comprises one or more component objects. In some examples of the method, non-transitory computer-readable medium, and apparatus described above, each of the one or more component objects may be based at least in part on a system object of the plurality of system objects.

Some examples of the method, non-transitory computer-readable medium, and apparatus described above may further include processes, features, means, or instructions for determining a size for each of the one or more component objects based at least in part on a depth first search of a nested set of component objects within the one or more components. Some examples of the method, non-transitory computer-readable medium, and apparatus described above may further include processes, features, means, or instructions for determining a total size of the at least one diagram figure based at least in part on the identified size for each of the one or more component objects. Some examples of the method, non-transitory computer-readable medium, and apparatus described above may further include processes, features, means, or instructions for determining a location for the at least one diagram figure based on the total size. Some examples of the method, non-transitory computer-readable medium, and apparatus described above may further include processes, features, means, or instructions for determining a location for each of the one or more component objects based at least in part on a breadth first search of the one or more component objects. In some examples of the method, non-transitory computer-readable medium, and apparatus described above, the location for each of the one or more component objects may be based on a layout direction variable, wherein the layout direction variable comprises a horizontal value, a vertical value, a column value, a row value, a circular value, or any combination thereof.

Some examples of the method, non-transitory computer-readable medium, and apparatus described above may further include processes, features, means, or instructions for identifying a nesting depth of a component object. Some examples of the method, non-transitory computer-readable medium, and apparatus described above may further include processes, features, means, or instructions for determining a value of the layout direction variable based at least in part on the nesting depth. In some examples of the method, non-transitory computer-readable medium, and apparatus described above, each of the one or more component objects comprises a component name. In some examples of the method, non-transitory computer-readable medium, and apparatus described above, each of the one or more component objects comprises a component reference number. In some examples of the method, non-transitory computer-readable medium, and apparatus described above, the component reference number may be the same as a component reference number of a corresponding component object in a specification document. In some examples of the method, non-transitory computer-readable medium, and apparatus described above, the component reference number comprises a dynamic field corresponding to a page number of the at least one diagram figure. In some examples of the method, non-transitory computer-readable medium, and apparatus described above, the component reference number comprises an underline format indicator, a lead line object, or both. In some examples of the method, non-transitory computer-readable medium, and apparatus described above, the at least one diagram object comprises a plurality of custom hardware component shapes and a plurality of block shapes.

### BRIEF DESCRIPTION OF THE DRAWINGS

FIGS. 1 through 3 show block diagrams that support preparing patent applications in accordance with aspects of the present disclosure.

FIGS. 4 through 12 show flowcharts that support preparing patent applications in accordance with aspects of the present disclosure.

### DETAILED DESCRIPTION

Methods, systems, and devices for automated patent preparation are described. A patent preparation system may facilitate efficient preparation of patent documents by identifying user input that includes an association of patent features (e.g., claims) with the components of a system that performs those features. The input may also include aspects of patent figures, acronyms, and other aspects of a patent disclosure. The user input may be used to create an application data object, which may then be used to create components of a patent including patent specification components and patent figures such as diagrams and flow charts. The generated components may be combined with templates to generate patent documents.

By receiving input in the form of an application data object and generating a specification data object (and, in some cases, a drawings data object), the system may store patent application information more efficiently (e.g., only a limited set of application inputs may be stored as opposed to a document that includes template information, boilerplate, and many repetitions of the same data) and avoid unnecessary repetition of certain patent drafting tasks. For example, the application data object may include an association of each claim element to a system component. A lookup function may then associate the system component with each of the associated. Thus, when generating a description of each figure that contains that component, an automated function can be applied to a list of features or elements associated with the component, thereby automatically providing structural support for a method claim, and support in the specification for claim elements.

Similarly, flowcharts may be automatically generated from claims and, since the claim elements have component associations, language may be automatically generated that states which system components perform each step of a flowchart, and automatically generate connecting language associating steps of a flowchart to descriptions of a diagram representing an apparatus including the relevant system components.

Also, figure numbering and written description numbering may be made consistent in an automated way by generating a list of components for each figure, assigning each component in the list a number (e.g., with a systematic algorithm such as adding 5 or 10 to the last component number) and doing a replace function on mentions of that component in a figure description. In some cases, automatic numbering insertion may utilize dynamic references instead of static numbers so that if figures or components are added in a word processing application such as Microsoft Word, the numbers are encoded with information that allows the word processing application to automatically renumber the figure components (i.e., using bookmarks and reference fields in the numbering elements that are inserted by the find and replace function).

In some examples, the system may utilize exceptions to prevent insertion of component numbers in undesired locations. For example, if one component is called component A and a second component is called component AB, the first component would be a substring of the second component, Thus, the system may create an exception such that it does not replace the string ‘component A’ in the with the component number for component A in the string component AB. In one embodiment this may be done using regular expressions to search for component names but exclude other ‘including’ component names.

In some cases, the system generates one extensible markup language (XML) objects corresponding to text or fields to be inserted into a template. The system may then decompress a template, identify the document XML, and insert the generated XML components into the document XML. The document XML may then be recompressed along with other files associated with the document to create a draft specification (or, as the case may be, the drawings). This may enable separate template and boilerplate information to be stored separately from the application inputs and may facilitate an automated process for generating patent document content and combining the generated application specific content with content from a template or library.

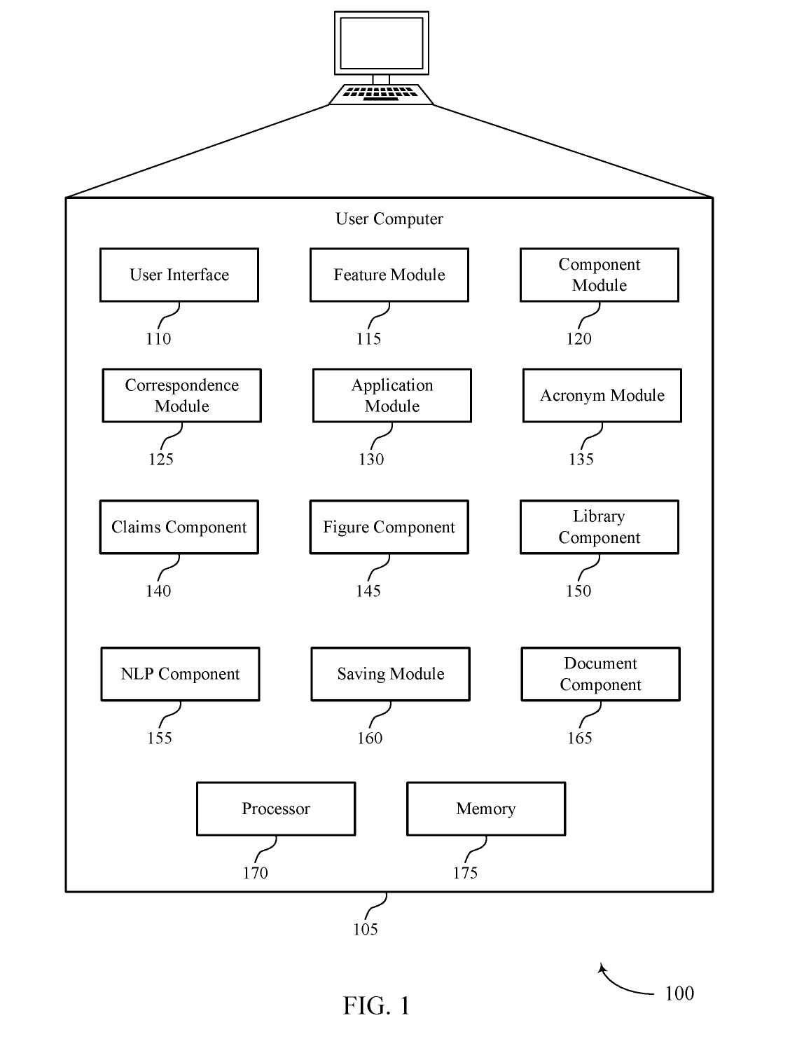

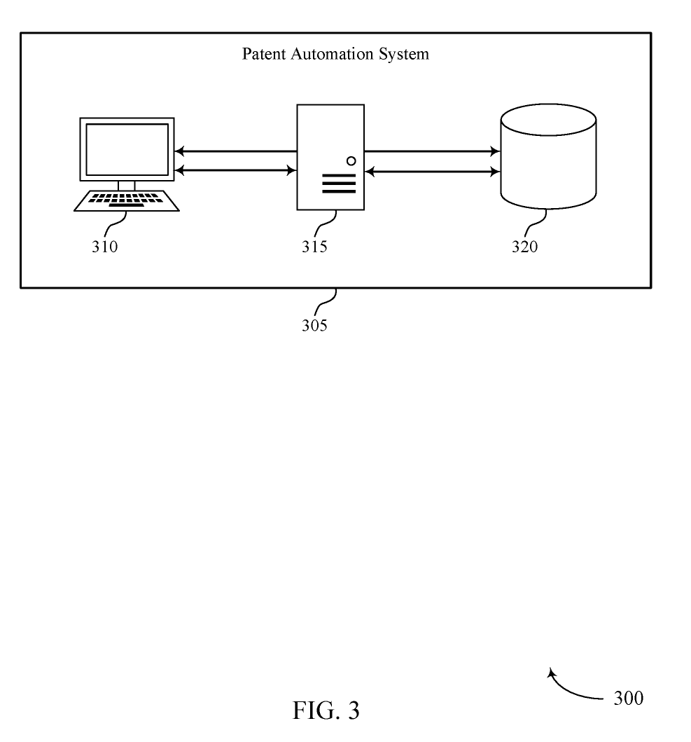

FIG. 1 shows a block diagram 100 that supports preparing patent applications in accordance with aspects of the present disclosure. Block diagram 100 may include user computer 105. User computer 105 may incorporate aspects of the corresponding components of the same name described with reference to FIG. 3. In some examples, user computer 105 may include the following components: user interface 110, feature module 115, component module 120, correspondence module 125, application module 130, acronym module 135, claims component 140, figure component 145, library component 150, NLP component 155, saving module 160, document component 165, processor 170, and memory 175. A user computer 105 may be an example of a personal computer, laptop computer, mainframe computer, palmtop computer, personal assistant, mobile device, or any other suitable processing apparatus.

User interface 110 may read one or more invention feature input fields of a user interface 110, wherein the plurality of features of the invention are identified based at least in part on the reading the invention feature input fields of the user interface 110; identify an in invalid input based on reading one or more invention feature input fields; display a warning indication on the user interface 110 based on the invalid input; display the plurality of features of the invention, the plurality of system components, the correspondence between each of the plurality of features of the invention and the system component of the plurality of system components, or any combination thereof on a user interface 110; identify a nested tree structure of display document objects based at least in part on a nested tree structure of the plurality of features of the invention, wherein the displaying is based on the nested tree structure of display document objects; identify a nested tree structure of display document objects based at least in part on a nested tree structure of figures of the invention; read one or more invention feature input fields, wherein the plurality of claims of the invention are identified based at least in part on the reading; and identify a text input, wherein the plurality of features of an invention are identified based at least in part on the text input.

User interface 110 may enable a user to interact with a device. In some embodiments, the user interface 110 module may include an audio device, such as an external speaker system, an external display device such as a display screen, or an input device (e.g., remote control device interfaced with the user interface 110 module directly or through the IO controller module). In some cases, the user interface 110 comprises a plurality of input sections, the plurality of input sections comprising an application data input section, a feature input section, a figure input section, an acronym input section, or any combination thereof.

In some cases, the feature input section and the figure input section each comprise a nested tree structure of display document objects. In some cases, the feature input section comprises one or more fields for associating the plurality of features of the invention and a system component of the plurality of system components. In some cases, the user interface 110 comprises a drag-and-drop function for manipulating a nested tree structure of the plurality of features of the invention, a figure of the invention, or both. In some cases, the user interface 110 comprises an editing function for editing text of the plurality of features of the invention, a figure of the invention, or both. In some cases, the user interface 110 comprises a structure editing function for manipulating a nested tree structure of the plurality of features of the invention, a figure of the invention, or both. In some cases, the structure editing function is based at least in part on association between arrow buttons on a user keyboard and structure manipulation subroutines for the nested tree structure.

In some cases, the invalid input is identified based at least in part on an information threshold, a missing input, a relationship between the one or more invention feature input fields, or any combination thereof. In some cases, the missing input comprises a missing system correspondence input for a feature of the plurality of features of an invention. In some cases, the user interface 110 comprises a plurality of input sections, the plurality of input sections comprising an application data input section, a feature input section, a figure input section, an acronym input section, or any combination thereof. In some cases, the nested tree structure of display document objects comprises a hypertext markup language (HTML) structure, a markup language tree structure, a scalable vector graphics (SVG) structure, or any combination thereof. In some cases, the text input is identified based on a user selected text document, pasted text input, an email input, a web based communication, or any combination thereof.

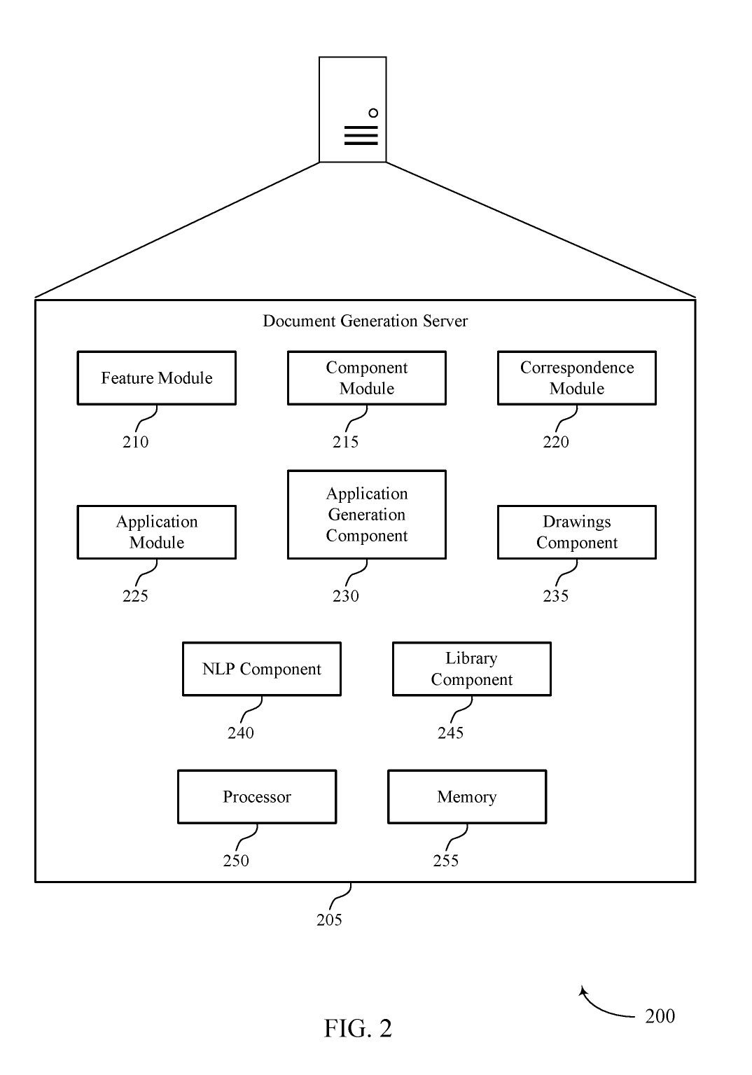

Feature module 115 may identify a plurality of features of an invention; identify a tree structure for the plurality of features of the invention, wherein the patent application data object is identified based at least in part on the tree structure; identify a third subset of the plurality of features of the invention as non-claim features; and determine whether a feature of the plurality of features of the invention is a claim feature, a device component, a method step, a discussion feature, a background feature, an enabling detail, a non-claim feature, a component relationship feature, or any combination thereof. Feature module 115 may incorporate aspects of the corresponding components of the same name described with reference to FIG. 2.

In some cases, the plurality of features of the invention comprise claim features, background details, invention details, enabling details, invention embodiment, invention components, method steps, or any combination thereof. In some cases, the determination is based at least in part on a feature category indication of a user interface 110.

Component module 120 may identify a plurality of system components. Component module 120 may incorporate aspects of the corresponding components of the same name described with reference to FIG. 2.

Correspondence module 125 may identify a correspondence between each of the plurality of features of the invention and a system component of the plurality of system components. Correspondence module 125 may incorporate aspects of the corresponding components of the same name described with reference to FIG. 2.

In some cases, the correspondence between each of the plurality of features of the invention and a system component of the plurality of system components is identified based at least in part on the natural language processing analysis.

Application module 130 may identify a patent application data object, wherein the patent application data object is based at least in part on the plurality of features of the invention and the correspondence between each of the plurality of features of the invention and the system component of the plurality of system components. Application module 130 may incorporate aspects of the corresponding components of the same name described with reference to FIG. 2.

Acronym module 135 may identify one or more acronym objects, wherein the patent application data object includes the one or more acronym objects. In some cases, the one or more acronym objects comprises a short version and a long version, wherein the short version comprises a subset of letters of the long version.

Claims component 140 may identify a first subset of the plurality of features of the invention as independent claim features, and a second subset of the plurality of features of the invention as dependent claim features; identify a plurality of claims, wherein the each of the plurality of claims comprises at least one of the plurality of features of the invention and wherein the patent application data object is identified based at least in part on the plurality of claims; identify a nested tree structure for the plurality of claims, wherein the nested tree structure is based at least in part on a dependency relationship between individual claims of the plurality of claims; and identify a plurality of claim types for each of the plurality of claims, wherein the plurality of claim types comprises a method claim type, a means plus function claim type, a computer readable medium claim type, a processor function claim type, a device claim type, a system claim type, a chemical composition claim type, a business method claim type, an apparatus claim type, or any combination thereof.

Figure component 145 may identify at least one patent figure, wherein the patent application data object is identified based at least in part on the at least one patent figure; identify a nested tree structure for the at least one patent figure, wherein the nested tree structure comprises a set of relationships among a plurality of method steps, a plurality of figure components 145, or both; identify at least one method step based at least in part on the plurality of features of the invention, wherein the flowchart figure comprises the method step; identify a system component for the at least one method step; identify at least one figure component 145, wherein the system diagram 100 figure comprises the at least one figure component 145; and identify a correspondence between the at least one figure component 145 and a subset of the plurality of features of the invention based at least in part on the correspondence between each of the plurality of features of the invention and the system component of the plurality of system components.

In some cases, the at least one figure comprises a flowchart figure. In some cases, the system component for the at least one method step is based at least in part on the correspondence between each of the plurality of features of the invention and the system component of the plurality of system components. In some cases, the at least one figure comprises a system diagram figure. In some cases, the at least one figure comprises size information, location information, numbering information, shape information, stencil information, component relationship information or any combination thereof.

Library component 150 may identify a technology tag, wherein the patent application data object comprises the technology tag; receive text from a database based at least in part on the technology tag; transmit text to a database based at least in part on the technology tag; receive a figure object from a data base based at least in part on the technology tag; and transmit a figure object to a database server based at least in part on the technology tag. Library component 150 may incorporate aspects of the corresponding components of the same name described with reference to FIG. 2.

In some cases, the plurality of features of the invention is based at least in part on the text received from the database. In some cases, the patent application data object comprises the figure object. In some cases, the figure object comprises a plurality of component objects organized according to a nested tree structure.

NLP component 155 may perform a natural language processing analysis on the plurality of features of the invention; modify at least one feature of the plurality of features of the invention according to a set of grammatical rules based at least in part on the natural language processing analysis, wherein the patent application data object comprises the modified at least one feature; and perform an automatic textual analysis comprising a natural language processing analysis, a punctuation analysis, a grammatical analysis or any combination thereof on the text input, wherein the plurality of features of the invention are identified based at least in part on the automatic textual analysis. NLP component 155 may incorporate aspects of the corresponding components of the same name described with reference to FIG. 2. In some cases, the set of grammatical rules comprises a list of specified grammatical constructions and a set of generic grammatical rules.

Saving module 160 may transmit the patent application data object to a database server; receive a verification from the database server in response to the transmission; save the patent application data object in a database based at least in part on client information, a docket number, a patent identifier, or any combination thereof; and identify an indication comprising a printing indication, a save indication, a user modification, a timer, or any combination thereof from a user interface 110, wherein the patent application data object is transmitted to the database server based at least in part on the indication.

Document component 165 may receive the patent application data object from a database server; transmit client information, a docket number, a patent identifier, or any combination thereof to the database server, wherein the patent application data object is received in response to the transmission; transmit the patent application data object to a document generation server; receive a drawings document from the document generation server in response to the transmission; receive a document link from the document generation server in response to the transmission; transmit a download request to the document generation server, wherein the drawings document is received based on the download request; receive a specification document from the document generation server; and transmit a download request to the document generation server, wherein the specification document is received based on the download request.

In some cases, the patent application data object comprises a JSON object, a JavaScript data object, an object oriented programming data object, a nodeJS data object, an extensible markup language (XML) object, an SQL data object, a graph database object, a relational database object, or any combination thereof. In some cases, the drawings document comprises a Microsoft Visio document, an image document, a portable document format (PDF) document, an SVG document, a diagram 100 document or any combination thereof. In some cases, the specification document comprises a Microsoft Word document, an open office XML document, a PDF document, a text document, or any combination thereof.

Processor 170 may incorporate aspects of the corresponding components of the same name described with reference to FIG. 2. Processor 170 may include an intelligent hardware device, (e.g., a general-purpose processing component, a DSP, a CPU, a microcontroller, an ASIC, an FPGA, a programmable logic device, a discrete gate or transistor logic component, a discrete hardware component, or any combination thereof). In some cases, the processor 170 may be configured to operate a memory 175 array using a memory 175 controller. In other cases, a memory 175 controller may be integrated into processor 170. The processor 170 may be configured to execute computer-readable instructions stored in a memory 175 to perform various functions. In some examples, a processor 170 may include special purpose components for modem processing, baseband processing, digital signal processing, or transmission processing. In some examples, the processor 170 may comprise a system-on-a-chip.

Memory 175 may incorporate aspects of the corresponding components of the same name described with reference to FIG. 2. Memory 175 may include RAM, ROM, or a hard disk. The memory 175 may be solid state or a hard disk drive, and may include store computer-readable, computer-executable software including instructions that, when executed, cause a processor 170 to perform various functions described herein. In some cases, the memory 175 may contain, among other things, a BIOS which may control basic hardware or software operation such as the interaction with peripheral components or devices.

FIG. 2 shows a block diagram 200 that supports preparing patent applications in accordance with aspects of the present disclosure. Block diagram 200 may include document generation server 205. Document generation server 205 may incorporate aspects of the corresponding components of the same name described with reference to FIG. 3. In some examples, document generation server 205 may include the following components: feature module 210, component module 215, correspondence module 220, application module 225, application generation component 230, drawings component 235, NLP component 240, library component 245, processor 250, and memory 255. In some cases, a document generation server 205 may be collocated or share components with a user computer as described in FIG. 1.

Feature module 210 may identify a plurality of features of an invention; identify a tree structure for the plurality of features of the invention, wherein the patent application data object is identified based at least in part on the tree structure; identify a third subset of the plurality of features of the invention as non-claim features; and determine whether a feature of the plurality of features of the invention is a claim feature, a device component, a method step, a discussion feature, a background feature, an enabling detail, a non-claim feature, a component relationship feature, or any combination thereof. Feature module 210 may incorporate aspects of the corresponding components of the same name described with reference to FIG. 1.

Component module 215 may identify a plurality of system components. Component module 215 may incorporate aspects of the corresponding components of the same name described with reference to FIG. 1.

Correspondence module 220 may identify a correspondence between each of the plurality of features of the invention and a system component of the plurality of system components. Correspondence module 220 may incorporate aspects of the corresponding components of the same name described with reference to FIG. 1.

Application module 225 may identify a patent application data object, wherein the patent application data object is based at least in part on the plurality of features of the invention and the correspondence between each of the plurality of features of the invention and the system component of the plurality of system components. Application module 225 may incorporate aspects of the corresponding components of the same name described with reference to FIG. 1.

Application generation component 230 may generate a claims section or a summary section of a patent application document based on the first subset and the second subset; generate a detailed description section of a patent application document based on the first subset, the second subset and the third subset; generate text for an application section of a patent application based at least in part on the application data object, wherein the application section comprises a claims section, a summary section, a background section, a references section, a brief description section, a detailed description section, a field of the invention section, a title section, an abstract section, or any combination thereof; and identify a claim form for each of a set of claim types of the patent application data object, wherein the text for the claims section is generated based at least in part on the claim form for each of the set of claim types.

Application generation component 230 may also generate a description for each of a set of components of a figure of the patent application data object based at least in part on a nested tree structure of the components within the patent application data object, wherein the at least one description of the block diagram 200 figure comprises the generated description; identify a subset of the plurality of features of the invention based at least in part on the correspondence between each of the plurality of features of the invention and the system component of the plurality of system components, wherein the generated description is based at least in part on the subset of the plurality of features of the invention; identify at least on feature based at least in part on a technology tag or a component name of the application data object, wherein the generated description is based at least in part on the at least one feature; identify a system component of the plurality of system components based at least in part on a correspondence between the system component a step of the plurality of steps in the application data object; generate component reference text based on the identified system component, wherein the description of a plurality of steps comprises the component reference text; and identify a set of figures that include the identified system component, wherein the component reference text is generated based at least in part on the set of figures.

Application generation component 230 may also identify a set of components or flowchart steps; identify a reference number for each of the set of components or flowchart steps; insert the reference number for each of the set of components or flowchart steps into the detailed description section; perform a search function on the detailed description section based on the set of components or flowchart steps, wherein inserting the reference number is based on the search function; perform a tree search function on a figure of the patent application data object; identify a count of the set of components or flowchart steps based at least in part on the tree search function, wherein the reference number for each of the set of components or flowchart steps is based at least in part on the count; determine whether a feature of the plurality of features comprises an active feature, a passive feature, a substep, a device component, a component detail, or any combination thereof based on a natural language processing analysis of the feature, wherein the text for the application section is based on the determination; perform a search and replace function for a set of acronyms of the application data object, wherein the text for the application section is based on the search and replace function; perform a grammatical transformation on at least one of the plurality of features of the invention, wherein the text for the application section is based at least in part on the grammatical transformation; and insert the text for the application section into a patent application template to form a patent application document.

Application generation component 230 may also delete excess markup from the patent application document; identify the excess markup based at least in part on a set of markup rules; delete excess markup from the patent application template, wherein the patent application document is based on deleting the excess markup; identify a one or more search terms within the patent application template, wherein the text for the application section is inserted based on the identified one or more search terms; identify a bookmark element within the patent application template, wherein the text for the application section is inserted based on the identified bookmark; identify one or more empty run elements within the patent application template; merge the one or more empty runs; identify one or more text runs; generate one or more text run markup sections based on the text runs; identify a set of paragraph properties; and generate a paragraph markup section based at least in part on the one or more text run markup sections and the set of paragraph properties, wherein the text for the application section comprises the paragraph markup section; insert a paragraph ending markup at the beginning of the text for the application section and a paragraph beginning markup at the end of the application section.

Application generation component 230 may also transform a gerund form of a feature of the plurality of features of the invention to an infinitive form of the feature, wherein the text of the application section is based at least in part on the transformation;

transform an infinitive form of a feature of the plurality of features of the invention to a gerund form of the feature, wherein the text of the application section is based at least in part on the transformation; identify a first letter of a component of the plurality of system components; identify an article based on the first letter; insert the article into the text of the application section; identify a first letter of a sentence; replace the first letter of a sentence with a capitalized version of the first letter of the sentence, wherein the text of the application section is based at least in part on the replacement; identify a list of elements; identify the last element of the list of elements, the penultimate element of the list of elements, or both; append a separator to one or more elements of the list of elements based at least in part on the identified last element of the list of elements, the identified penultimate element of the list of elements, or both; generate a text list of the list of elements based at least in part on the list of elements and the appended separators to the one or more elements, wherein the text of the application section is based at least in part on the text list; identify a file name for a patent application document based at least in part on the patent application data object; generate the patent application document based at least in part on the patent application data object; save the patent application document based at least in part on the file name; and transmit a document link to the patent application document based on the file name.

In some cases, the text for the application section comprises XML markup, plain text, text markup, or any combination thereof. In some cases, the text for the application section comprises formatting information, numbering information, list information, or any combination thereof. In some cases, the text for the application section comprises dynamic fields, sequential numbering fields, reference fields corresponding to figure numbers, dynamically updating claim numbers, reference fields corresponding to claim dependencies, or any combination thereof. In some cases, the text for the claims section is generated based at least in part on a nested tree structure of the plurality of features of the invention. In some cases, the claim form for each of the set of claim types comprises a feature grammatical form, a preamble form, or both. In some cases, the summary section comprises a plurality of repetitions for a first subset of the plurality of features of the invention and a single repetition for a second subset of the plurality of features of the invention based at least in part on the first subset being independent claim features and the second subset being dependent claim features. In some cases, the detailed description section comprises at least one description of a block diagram 200 figure.

In some cases, the generated description comprises a dynamic field indicating that a component described in the generated description corresponds to a description of a figure different from the block diagram 200 figure. In some cases, the detailed description section comprises at least one description of a flowchart. In some cases, the at least one description of the flowchart includes a description of a plurality of steps based on the plurality of features of the invention or a set of steps of a figure object of the application data object. In some cases, the brief description section comprises reference fields that correspond to figure numbers located in the detailed description section. In some cases, the brief description section comprises a listing of figures based at least in part on a set of figures of the application data object. In some cases, the listing of figures includes abbreviated ranges of figures based at least in part on one or more subsets of the set of figures having substantially similar figure names. In some cases, the brief description section comprises text based on an invention description field of the patent application data object. In some cases, the patent application data object comprises an indication of the patent application template, wherein inserting the text for the claims section is based at least in part on the indication of the patent application template.

Drawings component 235 may generate a drawings document based at least in part on the patent application data object; transmit the drawings document to a browser based application; generate at least one flowchart figure, at least one diagram 200 figure, or both based on the patent application data object, wherein the drawings document comprises the at least on flowchart figure, the at least one diagram 200 figure, or both; generate at least one step object, wherein the at least one flowchart figure comprises the at least one step object; perform a capitalization function on the text of the step object; perform a text simplification function on the text of the step object; identify a number of steps of the at least one flowchart figure, wherein the reference number is based on the number of steps; identify a standard distance between reference numbers and step objects; determine a location of the step object; determine a location of the reference number based at least in part on the location of the step object and the standard distance; identify a location of a step object; identify a standard distance between step objects and arrow objects; determine the location of an arrow object of the plurality of arrow objects based at least in part on the location of the step object and the standard distance; and identify a size of a first step object from a set of step objects of the at least one flowchart figure, wherein the size of the first step object is based at least in part on a length of text of the first step object.

Drawings component 235 may also identify a location of the first step object; determine a location of a second step object based at least in part on size of the first step object and the location of the first step object or based on a size of the second step object and the location of the first step object; identify a standard gap distance, wherein the location of the second step object is determined based at least in part on the standard gap distance; determine a size for each step object of a set of step objects of the at least one flowchart figure; determine a total size based at least in part on the size for each step object; determine a location of the at least one flowchart figure based on the total size; determine a location of each step object of the at least one flowchart figure based on the location of the at least one flowchart figure; perform a depth first search or a breadth first search on the set of step objects of the at least one flowchart figure, wherein the total size is based at least in part on the depth first search or the breadth first search; identify a master shape; modify one or more aspects of the master shape based at least in part on the patent application data object, wherein the at least one flowchart figure, the at least one diagram 200 figure, or both are based on the modified master shape; determine a size for each of the one or more component objects based at least in part on a depth first search of a nested set of component objects within the one or more components; determine a total size of the at least one diagram 200 figure based at least in part on the identified size for each of the one or more component objects; determine a location for the at least one diagram 200 figure based on the total size; determine a location for each of the one or more component objects based at least in part on a breadth first search of the one or more component objects; identify a nesting depth of a component object; and determine a value of the layout direction variable based at least in part on the nesting depth.

In some cases, the drawings document comprises a Microsoft Visio document, a diagram 200 document, an SVG document, an image document, a PDF document, or any combination thereof. In some cases, the at least one flowchart figure, the at least one diagram 200 figure, or both comprise an XML object that includes a plurality of XML shape objects. In some cases, the step object comprises a rectangular shape, a diamond shape, a circular shape, an oval shape, a rectangular shape with rounded corners, or any combination thereof. In some cases, the step object comprises text based at least in part on one of the plurality of features of the invention. In some cases, the step object comprises a lead line object. In some cases, the lead line object comprises a Non-uniform rational basis spline (NURBS) object. In some cases, the step object comprises an arrow object. In some cases, the step object comprises a reference number. In some cases, the reference number comprises a dynamic page reference. In some cases, the at least one flowchart figure comprises a plurality of arrow objects, wherein each of the arrow objects has a location between two step objects. In some cases, the at least one flowchart figure comprises a NURBS object.

In some cases, the master shape comprises an arrow master shape, a lead line master shape, a device master shape, a bus master shape, an electrical component master shape, a label master shape, or any combination thereof. In some cases, the at least one diagram 200 figure comprises one or more component objects. In some cases, each of the one or more component objects is based at least in part on a system object of the plurality of system objects. In some cases, the location for each of the one or more component objects is based on a layout direction variable, wherein the layout direction variable comprises a horizontal value, a vertical value, a column value, a row value, a circular value, or any combination thereof.

In some cases, each of the one or more component objects comprises a component name. In some cases, each of the one or more component objects comprises a component reference number. In some cases, the component reference number is the same as a component reference number of a corresponding component object in a specification document. In some cases, the component reference number comprises a dynamic field corresponding to a page number of the at least one diagram 200 figure. In some cases, the component reference number comprises an underline format indicator, a lead line object, or both. In some cases, the at least one diagram 200 object comprises a plurality of custom hardware component shapes and a plurality of block shapes.

NLP component 240 may perform a natural language processing analysis on the plurality of features of the invention; modify at least one feature of the plurality of features of the invention according to a set of grammatical rules based at least in part on the natural language processing analysis, wherein the patent application data object comprises the modified at least one feature; and perform an automatic textual analysis comprising a natural language processing analysis, a punctuation analysis, a grammatical analysis or any combination thereof on the text input, wherein the plurality of features of the invention are identified based at least in part on the automatic textual analysis. NLP component 240 may incorporate aspects of the corresponding components of the same name described with reference to FIG. 1.

Library component 245 may identify a technology tag, wherein the patent application data object comprises the technology tag; receive text from a database based at least in part on the technology tag; transmit text to a database based at least in part on the technology tag; receive a figure object from a data base based at least in part on the technology tag; and transmit a figure object to a database server based at least in part on the technology tag. Library component 245 may incorporate aspects of the corresponding components of the same name described with reference to FIG. 1.

Processor 250 may incorporate aspects of the corresponding components of the same name described with reference to FIG. 1. Memory 255 may incorporate aspects of the corresponding components of the same name described with reference to FIG. 1.

FIG. 3 shows a block diagram 300 of a patent automation system that supports preparing patent applications in accordance with aspects of the present disclosure. Block diagram 300 may include patent automation system 305. In some examples, patent automation system 305 may include the following components: user computer 310, document generation server 315, and database server 320. User computer 310 may incorporate aspects of the corresponding components of the same name described with reference to FIG. 1. Document generation server 315 may incorporate aspects of the corresponding components of the same name described with reference to FIG. 2. In some cases, each of these components may be collocated. In other cases, these components may be located separately.

In some examples, the patent automation system may include a user interface server (not shown) that may be separate from or collocated with the document generation server 315. The user interface server may, for example, provide a web interface to the user computer 310 (e.g., in the form of an HTML page). Database server 320 may represent a database configured to store the application data object and retrieve the application data object upon request from the user interface server, the user computer or the document generation server 315.

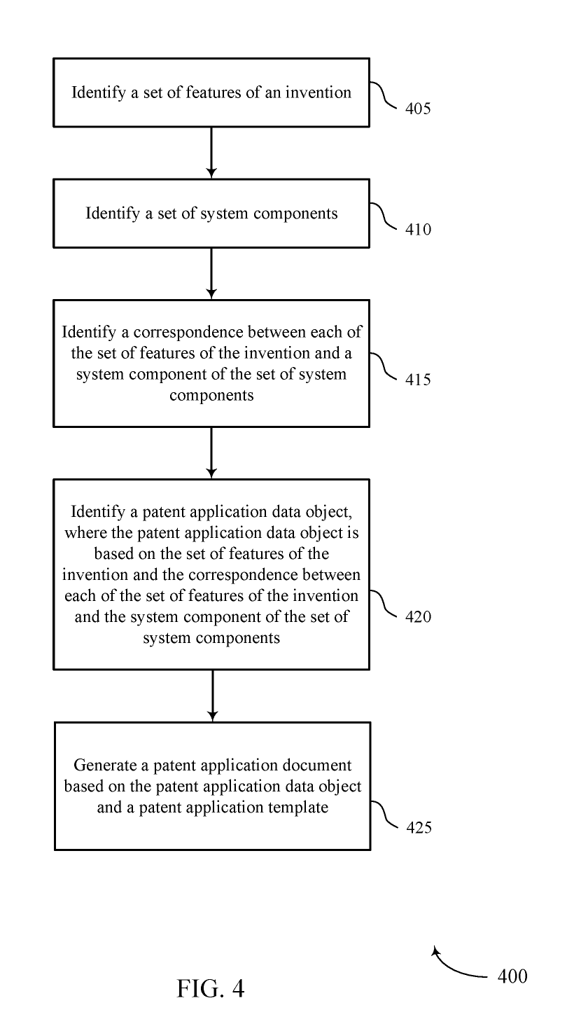

FIG. 4 shows a flowchart 400 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 405 the system or apparatus may identify a plurality of features of an invention. In certain examples, aspects of the described operations may be performed by a feature module as described with reference to FIGS. 1 and 2.

At step 410 the system or apparatus may identify a plurality of system components. In certain examples, aspects of the described operations may be performed by a component module as described with reference to FIGS. 1 and 2.

At step 415 the system or apparatus may identify a correspondence between each of the plurality of features of the invention and a system component of the plurality of system components. In certain examples, aspects of the described operations may be performed by a correspondence module as described with reference to FIGS. 1 and 2.

At step 420 the system or apparatus may identify a patent application data object, wherein the patent application data object is based at least in part on the plurality of features of the invention and the correspondence between each of the plurality of features of the invention and the system component of the plurality of system components. In certain examples, aspects of the described operations may be performed by an application module as described with reference to FIGS. 1 and 2.

At step 425 the system or apparatus may generate a patent application document based on the patent application data object and a patent application template. In certain examples, aspects of the described operations may be performed by an application generation component as described with reference to FIG. 2.

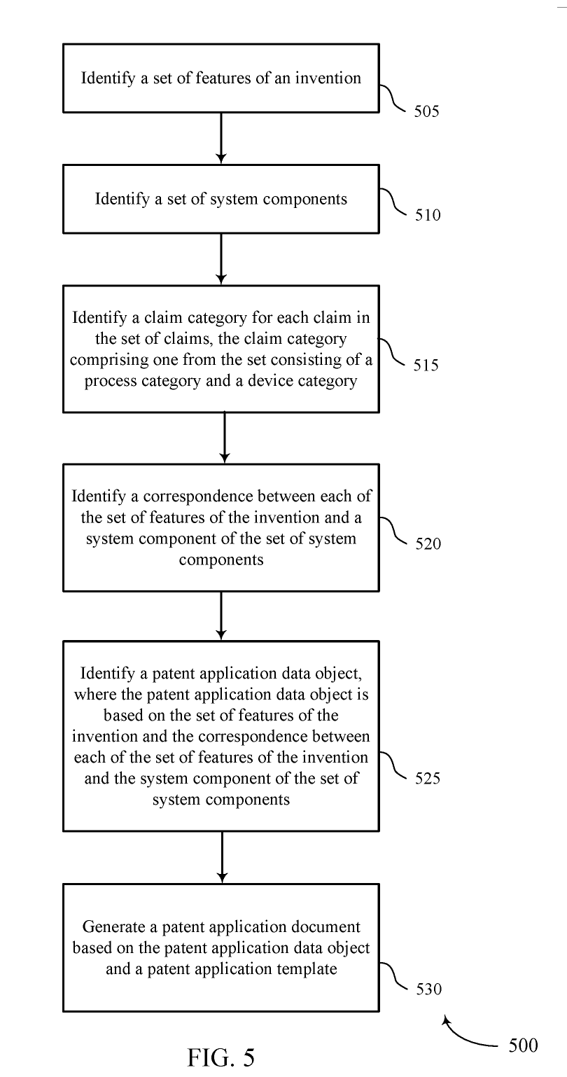

FIG. 5 shows a flowchart 500 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 505 the system or apparatus may identify a plurality of features of an invention. In certain examples, aspects of the described operations may be performed by a feature module as described with reference to FIGS. 1 and 2.

At step 510 the system or apparatus may identify a plurality of system components. In certain examples, aspects of the described operations may be performed by a component module as described with reference to FIGS. 1 and 2.

At step 515 the system or apparatus may identify a claim category for each claim in the set of claims, the claim category comprising one from the set consisting of a process category and a device category. The process category may represent all claims whose novelty is based on a process, regardless of whether the ultimate claim will be a method type claim. Device claims may be categorized based on whether the novelty is based on a configuration of physical elements, regardless of whether the claim will ultimately be written in a device or apparatus form.

At step 520 the system or apparatus may identify a correspondence between each of the plurality of features of the invention and a system component of the plurality of system components. In certain examples, aspects of the described operations may be performed by a correspondence module as described with reference to FIGS. 1 and 2.

At step 525 the system or apparatus may identify a patent application data object, wherein the patent application data object is based at least in part on the plurality of features of the invention and the correspondence between each of the plurality of features of the invention and the system component of the plurality of system components. In certain examples, aspects of the described operations may be performed by an application module as described with reference to FIGS. 1 and 2.

At step 530 the system or apparatus may generate a patent application document based on the patent application data object and a patent application template. In certain examples, aspects of the described operations may be performed by an application generation component as described with reference to FIG. 2.

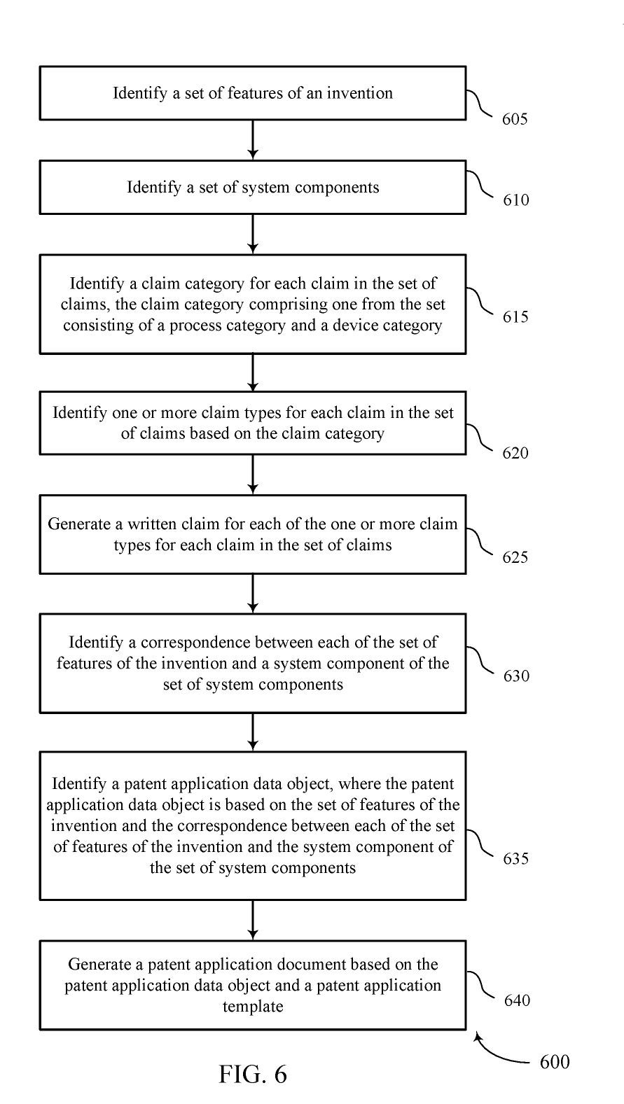

FIG. 6 shows a flowchart 600 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 605 the system or apparatus may identify a plurality of features of an invention. In certain examples, aspects of the described operations may be performed by a feature module as described with reference to FIGS. 1 and 2.

At step 610 the system or apparatus may identify a plurality of system components. In certain examples, aspects of the described operations may be performed by a component module as described with reference to FIGS. 1 and 2.

At step 615 the system or apparatus may identify a claim category for each claim in the set of claims, the claim category comprising one from the set consisting of a process category and a device category.

At step 620 the system or apparatus may identify one or more claim types for each claim in the set of claims based on the claim category. For example, the claim types may include a method, apparatus, means plus function, system, method of manufacture or method of use claim types. Other claim types are also possible, and claim types may be customized for a particular application or client. Each claim type format may include a verb form as well as other parameters such as a preamble form and transition phrases.

At step 625 the system or apparatus generate a written claim for each of the one or more claim types for each claim in the set of claims.

At step 630 the system or apparatus may identify a correspondence between each of the plurality of features of the invention and a system component of the plurality of system components. In certain examples, aspects of the described operations may be performed by a correspondence module as described with reference to FIGS. 1 and 2.

At step 635 the system or apparatus may identify a patent application data object, wherein the patent application data object is based at least in part on the plurality of features of the invention and the correspondence between each of the plurality of features of the invention and the system component of the plurality of system components. In certain examples, aspects of the described operations may be performed by an application module as described with reference to FIGS. 1 and 2.

At step 640 the system or apparatus may generate a patent application document based on the patent application data object and a patent application template. In certain examples, aspects of the described operations may be performed by an application generation component as described with reference to FIG. 2.

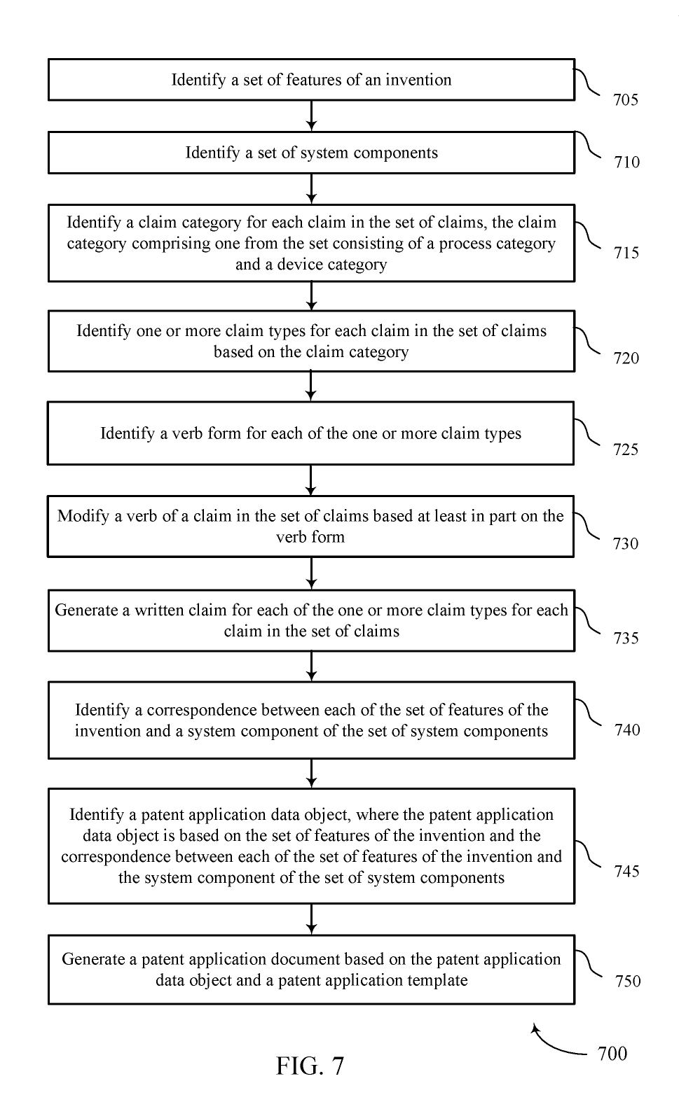

FIG. 7 shows a flowchart 700 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 705 the system or apparatus may identify a plurality of features of an invention. In certain examples, aspects of the described operations may be performed by a feature module as described with reference to FIGS. 1 and 2.

At step 710 the system or apparatus may identify a plurality of system components. In certain examples, aspects of the described operations may be performed by a component module as described with reference to FIGS. 1 and 2.

At step 715 the system or apparatus may identify a claim category for each claim in the set of claims, the claim category comprising one from the set consisting of a process category and a device category.

At step 720 the system or apparatus may identify one or more claim types for each claim in the set of claims based on the claim category. For example, the claim types may include a method, apparatus, means plus function, system, method of manufacture or method of use claim types. Other claim types are also possible, and claim types may be customized for a particular application or client. Each claim type format may include a verb form as well as other parameters such as a preamble form and transition phrases.

At step 725 the system or apparatus may identify a verb form for each of the one or more claim types. For example, the verb form may be an infinitive form or a gerund form.

At step 730 the system or apparatus may modify a verb of a claim in the set of claims based at least in part on the verb form. For example, a verb may be changed from a gerund form to an infinitive form, or vice versa.

At step 735 the system or apparatus generate a written claim for each of the one or more claim types for each claim in the set of claims. Thus, each claim is based on claim content from the application features combined with a claim template. Each claim from the application data object may be made into multiple claims by inserting the claim features into more than one claim template representing a particular claim type. This may increase efficiency by reducing the need to separately write multiple claims with similar content but different scope (i.e., a separate method claim and apparatus to perform the method claim). In some cases, the claim is written based on inserting a corresponding system component into the claim to identify the component that performs the function identified by the feature.

At step 740 the system or apparatus may identify a correspondence between each of the plurality of features of the invention and a system component of the plurality of system components. In certain examples, aspects of the described operations may be performed by a correspondence module as described with reference to FIGS. 1 and 2.

At step 745 the system or apparatus may identify a patent application data object, wherein the patent application data object is based at least in part on the plurality of features of the invention and the correspondence between each of the plurality of features of the invention and the system component of the plurality of system components. In certain examples, aspects of the described operations may be performed by an application module as described with reference to FIGS. 1 and 2.

At step 750 the system or apparatus may generate a patent application document based on the patent application data object and a patent application template. In certain examples, aspects of the described operations may be performed by an application generation component as described with reference to FIG. 2.

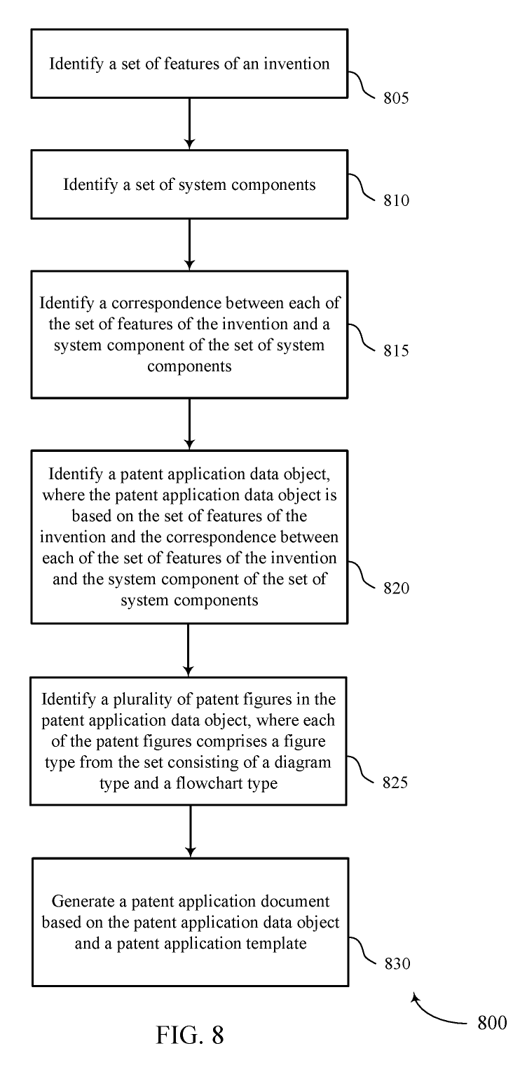

FIG. 8 shows a flowchart 800 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 805 the system or apparatus may identify a plurality of features of an invention. In certain examples, aspects of the described operations may be performed by a feature module as described with reference to FIGS. 1 and 2.

At step 810 the system or apparatus may identify a plurality of system components. In certain examples, aspects of the described operations may be performed by a component module as described with reference to FIGS. 1 and 2.

At step 815 the system or apparatus may identify a correspondence between each of the plurality of features of the invention and a system component of the plurality of system components. In certain examples, aspects of the described operations may be performed by a correspondence module as described with reference to FIGS. 1 and 2.

At step 820 the system or apparatus may identify a patent application data object, wherein the patent application data object is based at least in part on the plurality of features of the invention and the correspondence between each of the plurality of features of the invention and the system component of the plurality of system components. In certain examples, aspects of the described operations may be performed by an application module as described with reference to FIGS. 1 and 2.

At step 825 the system or apparatus may identify a plurality of patent figures in the patent application data object, where each of the patent figures comprises a figure type from the set consisting of a diagram type and a flowchart type. In certain examples, aspects of the described operations may be performed by an application generation component as described with reference to FIG. 2.

At step 830 the system or apparatus may generate a patent application document based on the patent application data object and a patent application template. In certain examples, aspects of the described operations may be performed by an application generation component as described with reference to FIG. 2.

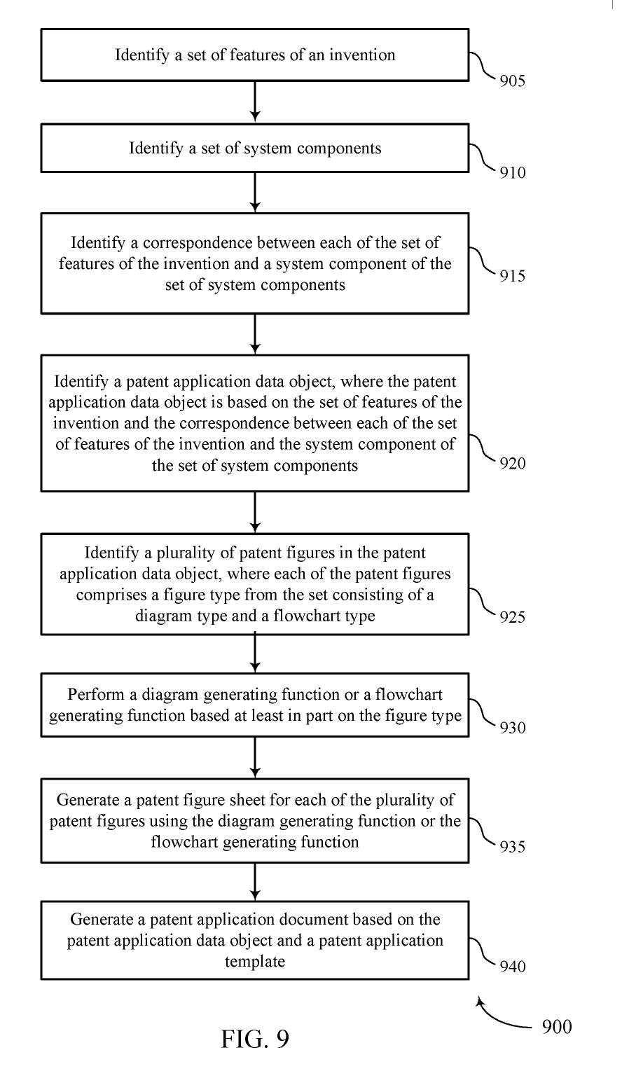

FIG. 9 shows a flowchart 900 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 905 the system or apparatus may identify a plurality of features of an invention. In certain examples, aspects of the described operations may be performed by a feature module as described with reference to FIGS. 1 and 2.

At step 910 the system or apparatus may identify a plurality of system components. In certain examples, aspects of the described operations may be performed by a component module as described with reference to FIGS. 1 and 2.

At step 915 the system or apparatus may identify a correspondence between each of the plurality of features of the invention and a system component of the plurality of system components. In certain examples, aspects of the described operations may be performed by a correspondence module as described with reference to FIGS. 1 and 2.

At step 920 the system or apparatus may identify a patent application data object, wherein the patent application data object is based at least in part on the plurality of features of the invention and the correspondence between each of the plurality of features of the invention and the system component of the plurality of system components. In certain examples, aspects of the described operations may be performed by an application module as described with reference to FIGS. 1 and 2.

At step 925 the system or apparatus may identify a plurality of patent figures in the patent application data object, where each of the patent figures comprises a figure type from the set consisting of a diagram type and a flowchart type. In certain examples, aspects of the described operations may be performed by an application generation component as described with reference to FIG. 2.

At step 930 the system or apparatus may perform a diagram generating function or a flowchart generating function based at least in part on the figure type. In certain examples, aspects of the described operations may be performed by an application generation component as described with reference to FIG. 2.

At step 935 the system or apparatus may generate a patent figure sheet for each of the plurality of patent figures using the diagram generating function or the flowchart generating function. In certain examples, aspects of the described operations may be performed by an application generation component as described with reference to FIG. 2.

At step 940 the system or apparatus may generate a patent application document based on the patent application data object and a patent application template. In certain examples, aspects of the described operations may be performed by an application generation component as described with reference to FIG. 2.

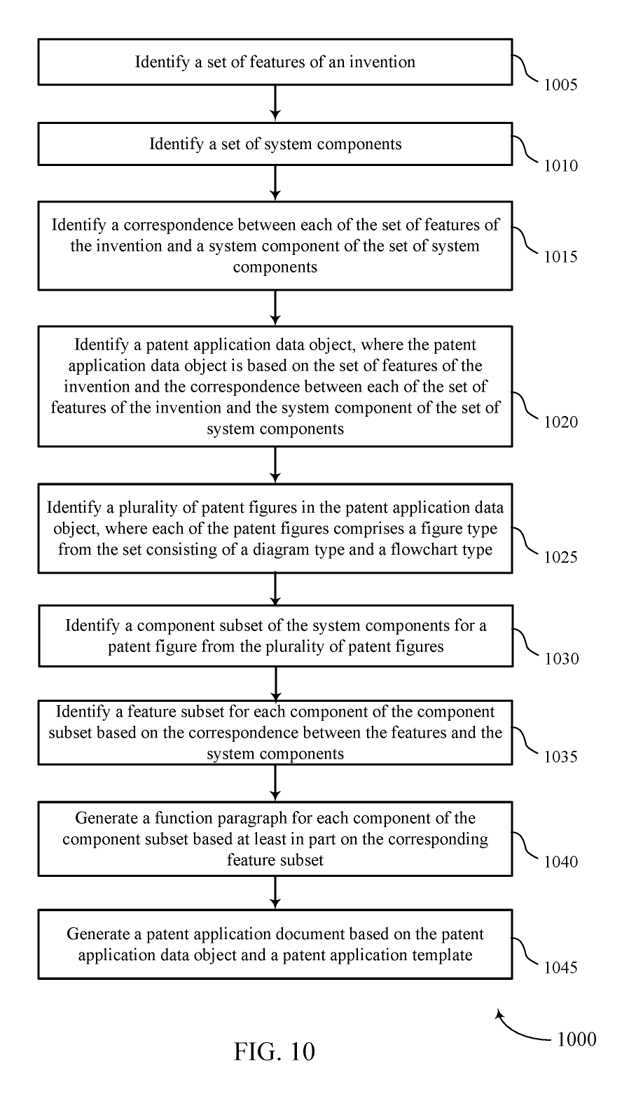

FIG. 10 shows a flowchart 1000 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 1005 the system or apparatus may identify a plurality of features of an invention. In certain examples, aspects of the described operations may be performed by a feature module as described with reference to FIGS. 1 and 2.

At step 1010 the system or apparatus may identify a plurality of system components. In certain examples, aspects of the described operations may be performed by a component module as described with reference to FIGS. 1 and 2.

At step 1015 the system or apparatus may identify a correspondence between each of the plurality of features of the invention and a system component of the plurality of system components. In certain examples, aspects of the described operations may be performed by a correspondence module as described with reference to FIGS. 1 and 2.

At step 1020 the system or apparatus may identify a patent application data object, wherein the patent application data object is based at least in part on the plurality of features of the invention and the correspondence between each of the plurality of features of the invention and the system component of the plurality of system components. In certain examples, aspects of the described operations may be performed by an application module as described with reference to FIGS. 1 and 2.

At step 1025 the system or apparatus may identify a plurality of patent figures in the patent application data object, where each of the patent figures comprises a figure type from the set consisting of a diagram type and a flowchart type. In certain examples, aspects of the described operations may be performed by an application generation component as described with reference to FIG. 2.

At step 1030 the system or apparatus may identify a component subset of the system components for a patent figure from the plurality of patent figures. At step 1035 the system or apparatus may identify a feature subset for each component of the component subset based on the correspondence between the features and the system components.

At step 1040 the system or apparatus may generate a function paragraph for each component of the component subset based at least in part on the corresponding feature subset. Thus, the connection between the features of an application and the structure that performs the function of the invention or the components of the inventive apparatus may be made explicit so that each of the claim elements is automatically supported in the specification. In some examples, the paragraph numbering may also be inserted into the generated paragraphs so that the numbering of the specification automatically corresponds to the numbering in the figures.

At step 1045 the system or apparatus may generate a patent application document based on the patent application data object and a patent application template. In certain examples, aspects of the described operations may be performed by an application generation component as described with reference to FIG. 2.

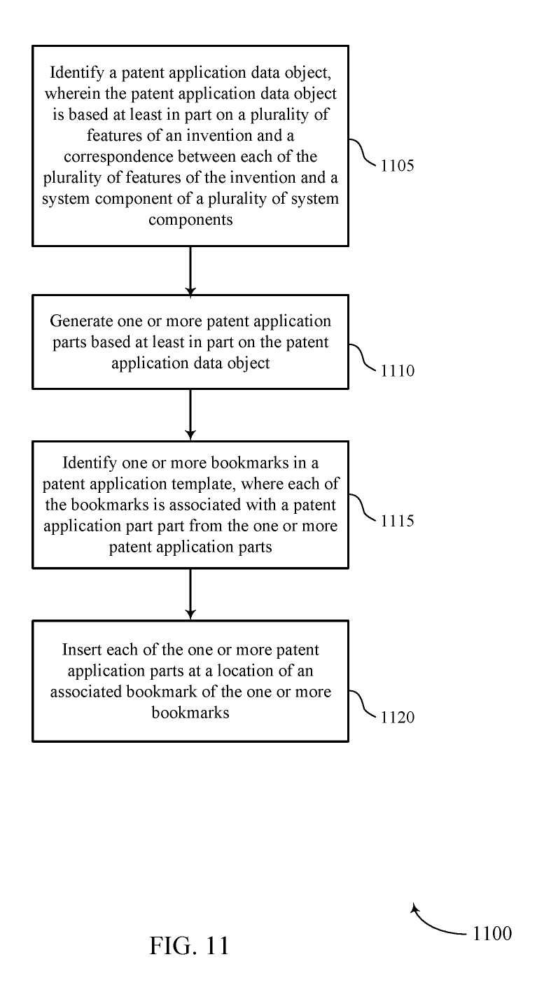

FIG. 11 shows a flowchart 1100 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 1105 the system or apparatus may identify a patent application data object, wherein the patent application data object is based at least in part on a plurality of features of an invention and a correspondence between each of the plurality of features of the invention and a system component of a plurality of system components.

At step 1110 the system or apparatus may generate one or more patent application parts based at least in part on the patent application data object.

At step 1115 the system or apparatus may identify one or more bookmarks in a patent application template, where each of the bookmarks is associated with a patent application part part from the one or more patent application parts.

At step 1120 the system or apparatus may insert each of the one or more patent application parts at a location of an associated bookmark of the one or more bookmarks.

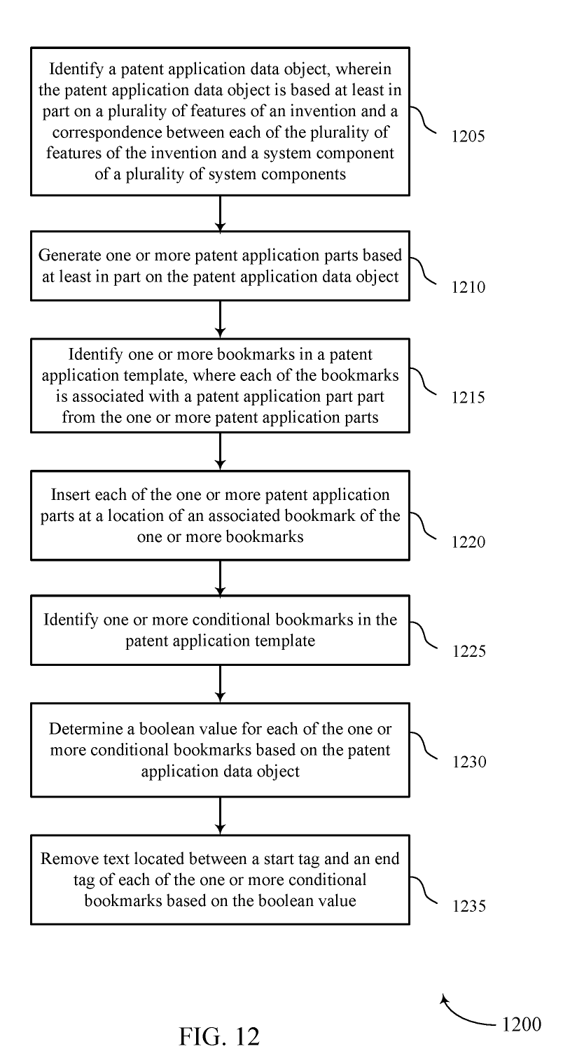

FIG. 12 shows a flowchart 1200 that supports preparing patent applications in accordance with aspects of the present disclosure. In some examples, a system or apparatus may execute a set of codes to control the functional elements of the device to perform the described functions. Additionally or alternatively, the system or apparatus may perform aspects of the functions described below using special-purpose hardware.

At step 1205 the system or apparatus may identify a patent application data object, wherein the patent application data object is based at least in part on a plurality of features of an invention and a correspondence between each of the plurality of features of the invention and a system component of a plurality of system components.

At step 1210 the system or apparatus may generate one or more patent application parts based at least in part on the patent application data object.

At step 1215 the system or apparatus may identify one or more bookmarks in a patent application template, where each of the bookmarks is associated with a patent application part part from the one or more patent application parts.

At step 1220 the system or apparatus may insert each of the one or more patent application parts at a location of an associated bookmark of the one or more bookmarks.

At step 1225 the system or apparatus may identify one or more conditional bookmarks in the patent application template.

At step 1230 the system or apparatus may determine a boolean value for each of the one or more conditional bookmarks based on the patent application data object.

At step 1235 the system or apparatus may remove text located between a start tag and an end tag of each of the one or more conditional bookmarks based on the boolean value.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read only memory (ROM), electrically erasable programmable read only memory (EEPROM), compact disk (CD) ROM or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, digital subscriber line (DSL), or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

In this disclosure, the terms “module” and “component” may be used interchangeably, and may represent both hardware components (e.g., an ASIC as described above) or software components.

What is claimed is:

1. A method for preparing patent applications, comprising:
identifying a plurality of features of an invention;
identifying a plurality of system components;
identifying a correspondence between each of the plurality of features of the invention and a system component of the plurality of system components; and
identifying a patent application data object, wherein the patent application data object is based at least in part on the plurality of features of the invention and the correspondence between each of the plurality of features of the invention and the system component of the plurality of system components; and
generating a patent application document based at least in part on the patent application data object and a patent application template.

2. The method of claim 1, wherein one or more of the plurality of features are grouped into a set of claims, the method further comprising:
identifying a claim category for each claim in the set of claims, the claim category comprising one from the set consisting of a process category and a device category.

3. The method of claim 2, further comprising:
identifying one or more claim types for each claim in the set of claims based on the claim category; and
generating a written claim for each of the one or more claim types for each claim in the set of claims.

4. The method of claim 3, wherein generating the written claim comprises:
identifying a verb form for each of the one or more claim types; and
modifying a verb of a claim in the set of claims based at least in part on the verb form.

5. The method of claim 1, further comprising:
identifying a plurality of patent figures in the patent application data object, wherein each of the plurality of patent figures comprises a figure type from a set of figure types consisting of a diagram type and a flowchart type.

6. The method of claim 6, wherein generating the patent application document comprises:
performing a diagram generating function or a flowchart generating function based at least in part on the figure type; and
generating a patent figure sheet for each of the plurality of patent figures using the diagram generating function or the flowchart generating function.

7. The method of claim 5, wherein generating the patent application document further comprises:
identifying a component subset of the plurality of system components for a patent figure from the plurality of patent figures;
identifying a feature subset of the plurality of features for each component of the component subset based on the correspondence between each of the plurality of features and the plurality of system components;
generating a function paragraph for each component of the component subset based at least in part on the corresponding feature subset.

8. A method of preparing patent applications comprising:
identifying a patent application data object, wherein the patent application data object is based at least in part on a plurality of features of an invention and a correspondence between each of the plurality of features of the invention and a system component of a plurality of system components;
generating one or more patent application parts based at least in part on the patent application data object;
identifying one or more bookmarks in a patent application template, wherein each of the one or more bookmarks is associated with a patent application part part from the one or more patent application parts;
inserting each of the one or more patent application parts at a location of an associated bookmark of the one or more bookmarks.

9. The method of claim 10, further comprising:
identifying one or more conditional bookmarks in the patent application template;
determining a boolean value for each of the one or more conditional bookmarks based on the patent application data object; and
removing text located between a start tag and an end tag of each of the one or more conditional bookmarks based on the boolean value.

10. A system for preparing patent applications comprising:
a user interface server configured to provide a user interface to a user;
a document generation server configured to:
identify a patent application data object, wherein the patent application data object is based at least in part on a plurality of features of an invention and a correspondence between each of the plurality of features of the invention and a system component of a plurality of system components; and
generate a patent application document based at least in part on the patent application data object and a patent application template; and the system further comprising:
a database configured to store the application data object and retrieve the application data object upon request from the user interface or the document generation server.
